(19) United States
(12) Patent Application Publication
(10) Pub. No.: US 2025/0147183 A1
(43) Pub. Date: May 8, 2025

(54) SYSTEM AND METHOD FOR OBJECT COMPREHENSION

(71) Applicant: Singulos Research Inc., Burnaby (CA)

(72) Inventors: Scott CHIN, Vancouver (CA); Bradley QUINTON, Vancouver (CA); Trent MCCLEMENTS, Burnaby (CA); Michael LEE, North Vancouver (CA)

(21) Appl. No.: 18/836,968

(22) PCT Filed: Feb. 10, 2023
(86) PCT No.: PCT/CA2023/050178

§ 371 Date: Aug. 8, 2024

Related U.S. Application Data
(60) Provisional application No. 63/308,894, filed on Feb. 10, 2022.

(51) Int. Cl. G01S 17/66

(52) U.S. Cl. CPC G01S 17/66

(57) ABSTRACT

In an aspect, the present disclosure provides systems, methods, and computer readable mediums for tracking objects of interest in an environment. A method for tracking objects of interest may include, for example, acquiring, from a sensor, a plurality of observations of the environment, each observation associated with a pose of the sensor for use in transforming between location coordinates in the plurality of observations and location coordinates in the environment; identifying an object at an object location within an observation of the plurality of observation; transforming, based on the pose of the sensors associated with the observation, the location of the object within the observation to an object location in the environment; identifying the object in a different observation of the plurality of observations based on a correspondence between a location of the object within the different observation and the object location in the environment.

### CROSS REFERENCE

This application claims the benefit of priority of U.S. Provisional Patent Application No. 63/308,894 filed on Feb. 10, 2022, and entitled METHOD AND APPARATUS FOR SEMANTIC OBJECT COMPREHENSION OVER TIME AND SPACE, the entirety of which is herein incorporated by reference.

### FIELD

The present disclosure relates generally to object comprehension, and more particularly to identifying and tracking objects in an environment, and even more particularly to identifying and tracking objects in an environment with mixed-reality systems.

### BACKGROUND

Mixed-reality systems include sensors for making observations and gathering data from the surrounding environment, such as gathering image data, for use in developing a semantic comprehension of objects in the environment and/or the environment itself. Examples of some sensors used in mixed-reality systems to develop a semantic comprehension include video cameras and laser imaging, detection, and ranging (LiDAR) sensors. The physical environment data may be modelled as a stream of data; the sensors may be thought of as sampling the physical environment, each sample providing a new observation, data frame, or the like. For example, a video camera which produces video data may model the physical environment as a stream of images at a particular frame rate.

Machine learning methods such as object detection, image classification, and object segmentation, may be applied to train mixed-reality systems to process the physical environment data. For example, sensor data, such as image data, may input to the mixed-reality systems, which can be trained to output a set of predictions for each data frame based on the machine learning methods. The output predictions can be further modelled as a stream of predictions for use in developing a semantic comprehension of the environment.

It remains desirable therefore, to develop further improvements and advancements in relation to object comprehension and mixed-reality systems, including but not limited to improving machine learning methods, improving predictions, and improving methods for developing a semantic comprehension of objects in the environment and/or the environment itself, to overcome shortcomings of known techniques, and to provide additional advantages thereto.

This section is intended to introduce various aspects of the art, which may be associated with the present disclosure. This discussion is believed to assist in providing a framework to facilitate a better understanding of particular aspects of the present disclosure. Accordingly, it should be understood that this section should be read in this light, and not necessarily as admissions of prior art.

### BRIEF DESCRIPTION OF THE DRAWINGS

Embodiments of the present disclosure will now be described, by way of example only, with reference to the attached Figures.

FIGS. 1A-1C illustrate a scene of capturing 2D images of objects in an environment from different observing perspectives in accordance with an embodiment of the present disclosure.

FIG. 2 is a block diagram of an embodiment of dynamic object comprehension engine for tracking objects in environment in accordance with the present disclosure.

FIG. 3 is a block diagram of an embodiment of a neural engine for generating a prediction frame in accordance with the present disclosure.

FIG. 4 is a block diagram of an illustrative example of a neural engine generating a prediction frame in accordance with an embodiment of the present disclosure.

FIG. 5 is a block diagram of an embodiment of a perception engine for managing a collection of objects in the environment in accordance with the present disclosure.

FIG. 6 is a flow chart of an embodiment of a method for generating a correspondence map in accordance with the present disclosure.

FIG. 7 is an illustrative example of an observing perspective in accordance with an embodiment of the present disclosure.

FIG. 8 is a flow chart of an embodiment of a method for merging a candidate object with a tracked object.

FIG. 9 illustrates an embodiment of a tracked property and an embodiment of a method for updating the tracked property in accordance with the present disclosure.

FIG. 10 illustrates an embodiment of a tracked object and an embodiment of a method for updating the tracked object in accordance with the present disclosure.

FIG. 11 illustrates a flow chart of an embodiment of a method for identifying and tracking objects of interest in accordance with the present disclosure.

FIG. 12 is a block diagram of an example computing device or system for implementing one or more systems, aspects, embodiments, methods, or operations of the present disclosure.

Throughout the drawings, sometimes only one or fewer than all of the instances of an element visible in the view are designated by a lead line and reference character, for the sake only of simplicity and to avoid clutter. It will be understood, however, that in such cases, in accordance with the corresponding description, that all other instances are likewise designated and encompasses by the corresponding description.

### DETAILED DESCRIPTION

The following are examples of systems and methods for object comprehension in accordance with the present disclosure.

According to an aspect, the present disclosure provides a method for tracking objects of interest in an environment, which may include: acquiring, from a sensor, a plurality of observations of the environment, each observation associated with a pose of the sensor for use in transforming between location coordinates in the plurality of observations and location coordinates in the environment; identifying an object at a location within an observation of the plurality of observations; transforming, based on the pose of the sensor associated with the observation, the location of the object within the observation to an object location within the environment, and identifying the object in a different observation of the plurality of observations based on a correspondence between a location of the object within the different observation and the object location in the environment.

In an example embodiment, tracking objects of interest in the environment may further include identifying the object in the observation based on a first trackable property associated with an object of interest, and identifying the object in the different observation based on a second trackable property associated with the object of interest.

In an example embodiment, tracking objects of interest in the environment may further include associating each of the first trackable property and the second trackable property with the object location within the environment.

In an example embodiment, the first trackable property and the second trackable property comprise a same trackable property of the object of interest.

In an example embodiment, tracking objects of interest in the environment may further include updating a semantic comprehension of the object based on at least one of the first trackable property, the second trackable property, and the location of the object within the different observation.

In an example embodiment, tracking objects of interest in the environment may further include determining a first observing perspective for the first tracked property and a second observing perspective for the second tracked property based on the sensor pose respectively associated with the observation and the different observation and the location of the object within the environment.

In an example embodiment, updating the semantic comprehension based on the first trackable property and/or the second trackable property is further based on determining a uniqueness of the first and second observing perspectives.

In an example embodiment, tracking objects of interest in the environment may further include maintaining a collection of objects identified in the environment, the collection of objects comprising candidate objects and tracked objects.

In an example embodiment, tracking objects of interest in the environment may further include identifying a tracked object in the collection of objects based on a tracked object correspondence.

In an example embodiment, tracking objects of interest in the environment may further include determining the tracked object correspondence based on a tracked object distance between the object and each of the tracked objects.

In an example embodiment, the tracked object distance comprises at least one of a Euclidean distance, a Manhattan distance, or a Minkowski distance, between the object location within the environment and a tracked object location within the environment.

In an example embodiment, the tracked object comprises the tracked object distance having a shortest distance to the object.

In an example embodiment, tracking objects of interest in the environment may further include determining a tracked property correspondence between the object and the tracked object, the tracked property correspondence based on correspondence between each of the first and second tracked property, and one or more tracked properties of the tracked object.

In an example embodiment, tracking objects of interest in the environment may further include merging the object with the tracked object based on a merging criteria.

In an example embodiment, the merging criteria comprises a maximum distance and wherein the shortest distance between the object and the tracked object is less than the maximum distance of the merging criteria.

In an example embodiment, the object does not meet the merging criteria, an example embodiment of tracking objects of interest in the environment may further include registering the object as a new candidate object in the collection of objects.

In an example embodiment, tracking objects of interest in the environment may further include identifying a candidate object in the collection of objects based on a candidate object correspondence.

In an example embodiment, tracking objects of interest in the environment may further include determining the candidate object correspondence based on a candidate object distance between the object and each of the candidate objects.

In an example embodiment, the candidate object distance comprises at least one of a Euclidean distance, a Manhattan distance, or a Minkowski distance, between the object location within the environment and a candidate object location within the environment.

In an example embodiment, the candidate object comprises the candidate object distance having a shortest distance to the object.

In an example embodiment, tracking objects of interest in the environment may further include determining a candidate property correspondence between the object and the candidate object, the tracked property correspondence based on correspondence between each of the first and second tracked property, and one or more tracked properties of the candidate object.

In an example embodiment, tracking objects of interest in the environment may further include merging the object with the candidate object based on a merging criteria.

In an example embodiment, the merging criteria comprises a maximum distance and wherein the shortest distance between the object and the candidate object is less than the maximum distance of the merging criteria.

In an example embodiment, tracking objects of interest in the environment may further include promoting the candidate object as a new tracked object in the collection of objects based on a promotion criteria.

In an example embodiment, the promotion criteria comprises a semantic comprehension threshold criteria.

In an example embodiment, the sensor comprises a range finder for determining a sensor-object distance between the sensor and the object.

According to an aspect, the present disclosure provides a method for tracking objects of interest in an environment, which may include: acquiring, from a sensor, a plurality of observations of the environment, each observation associated with a pose of the sensor for use in transforming between location coordinates in the plurality of observations and location coordinates in the environment; identifying a candidate object at a location within an observation of the plurality of observations based on a first trackable property associated with an object of interest; transforming, based on the associated sensor pose, the location of the candidate object within the observation to a candidate object location within the environment; identifying an object at a location within a different observation of the plurality of observations based on a second trackable property associated with the object of interest, and determining a correspondence between the location of the object within the different observation and the candidate object location within the environment and, based on the correspondence: merging the object with the candidate object, or disregarding the object as the candidate object and registering the object as a new candidate object.

In an example embodiment, merging comprises updating the candidate object location within the environment based on the location of the object in the different observation.

In an example embodiment, the first trackable property and the second trackable property comprise a same trackable property associated with the object of interest.

In an example embodiment, merging comprises updating a trackable property of the candidate object based on the first trackable property and the second trackable property.

In an example embodiment, merging comprises updating a semantic comprehension of the candidate object based on the updating of the trackable property.

In an example embodiment, the semantic comprehension comprises a confidence measure of the candidate object comprising the trackable property

In an example embodiment, tracking objects of interest in the environment may further include promoting the candidate object to a tracked object based on the semantic comprehension exceeding a semantic comprehension criteria.

According to an aspect, the present disclosure provides a method for tracking objects of interest in an environment, which may include: maintaining a collection of a plurality of tracked objects identified in the environment, the plurality of tracked objects each comprising: one or more trackable properties associated with an object of interest, and a tracked object location within the environment; acquiring, from a sensor, a plurality of observations of the environment, each observation associated with a pose of the sensor for use in transforming between location coordinates in the plurality of observations and location coordinates in the environment; identifying an object at a location within an observation of the plurality of observations, the object comprising a trackable property associated with the object of interest; transforming, based on the associated sensor pose, the location of the object within the observation to a predicted location within the environment; determining a correspondence between the object and each of the plurality of tracked objects based on a distance between the predicted location within the environment and the tracked object location within the environment; identifying the correspondence to a tracked object having the highest correspondence, and, based on the correspondence: merging the object with the tracked object, or registering the object as a new candidate object for maintaining in a collection of candidate objects.

According to an aspect, the present disclosure provides a system for tracking objects of interest in an environment, the system may include a sensor; one or more processors, and a memory storing instructions thereon that, when executed by the one or more processors, configure the system to: acquire, from the sensor, a plurality of observations of the environment, each observation associated with a pose of the sensor for use in transforming between location coordinates in the plurality of observations and location coordinates in the environment; identify an object at a location within an observation of the plurality of observations; transform, based on the pose of the sensor associated with the observation, the location of the object within the observation to an object location within the environment, and identify the object in a different observation of the plurality of observations based on a correspondence between a location of the object within the different observation and the object location in the environment.

In an example embodiment, the system may be further configured to: identify the object in the observation based on a first trackable property associated with an object of interest, and identify the object in the different observation based on a second trackable property associated with the object of interest.

In an example embodiment, the system may be further configured to associate each of the first trackable property and the second trackable property with the object location within the environment.

In an example embodiment, the first trackable property and the second trackable property comprise a same trackable property of the object of interest.

In an example embodiment, the system may be further configured to update a semantic comprehension of the object based on at least one of the first trackable property, the second trackable property, and the location of the object within the different observation.

In an example embodiment, the system may be further configured to determine a first observing perspective for the first tracked property and a second observing perspective for the second tracked property based on the sensor pose respectively associated with the observation and the different observation and the location of the object within the environment.

In an example embodiment, updating the semantic comprehension based on the first trackable property and/or the second trackable property is further based on determining a uniqueness of the first and second observing perspectives.

In an example embodiment, the system may be further configured to maintain a collection of objects identified in the environment, the collection of objects comprising candidate objects and tracked objects.

In an example embodiment, the system may be further configured to identify a tracked object in the collection of objects based on a tracked object correspondence.

In an example embodiment, the system may be further configured to determine the tracked object correspondence based on a tracked object distance between the object and each of the tracked objects.

In an example embodiment, the tracked object distance comprises at least one of a Euclidean distance, a Manhattan distance, or a Minkowski distance, between the object location within the environment and a tracked object location within the environment.

In an example embodiment, the tracked object comprises the tracked object distance having a shortest distance to the object.

In an example embodiment, the system may be further configured to determine a tracked property correspondence between the object and the tracked object, the tracked property correspondence based on correspondence between each of the first and second tracked property, and one or more tracked properties of the tracked object.

In an example embodiment, the system may be further configured to merge the object with the tracked object based on a merging criteria.

In an example embodiment, the merging criteria comprises a maximum distance and wherein the shortest distance between the object and the tracked object is less than the maximum distance of the merging criteria.

In an example embodiment, the object does not meet the merging criteria, the system further configured to register the object as a new candidate object in the collection of objects.

In an example embodiment, the system may be further configured to identify a candidate object in the collection of objects based on a candidate object correspondence.

In an example embodiment, the system may be further configured to determine the candidate object correspondence based on a candidate object distance between the object and each of the candidate objects.

In an example embodiment, the candidate object distance comprises at least one of a Euclidean distance, a Manhattan distance, or a Minkowski distance, between the object location within the environment and a candidate object location within the environment.

In an example embodiment, the candidate object comprises the candidate object distance having a shortest distance to the object.

In an example embodiment, the system may be further configured to determine a candidate property correspondence between the object and the candidate object, the tracked property correspondence based on correspondence between each of the first and second tracked property, and one or more tracked properties of the candidate object.

In an example embodiment, the system may be further configured to merge the object with the candidate object based on a merging criteria.

In an example embodiment, the merging criteria comprises a maximum distance and wherein the shortest distance between the object and the candidate object is less than the maximum distance of the merging criteria.

In an example embodiment, the system may be further configured to promote the candidate object as a new tracked object in the collection of objects based on a promotion criteria.

In an example embodiment, the promotion criteria comprises a semantic comprehension threshold criteria.

In an example embodiment, the sensor comprises a range finder for determining a sensor-object distance between the sensor and the object.

According to an aspect, the present disclosure provides a system for tracking objects of interest in an environment, the system may include: a sensor; one or more processors, and a memory storing instructions thereon that, when executed by the one or more processors, configure the system to: acquire, from the sensor, a plurality of observations of the environment, each observation associated with a pose of the sensor for use in transforming between location coordinates in the plurality of observations and location coordinates in the environment; identify a candidate object at a location within an observation of the plurality of observations based on a first trackable property associated with an object of interest; transform, based on the associated sensor pose, the location of the candidate object within the observation to a candidate object location within the environment; identify an object at a location within a different observation of the plurality of observations based on a second trackable property associated with the object of interest, and determine a correspondence between the location of the object within the different observation and the candidate object location within the environment and, based on the correspondence: merge the object with the candidate object, or disregard the object as the candidate object and register the object as a new candidate object.

In an example embodiment, merging comprises updating the candidate object location within the environment based on the location of the object in the different observation.

In an example embodiment, the first trackable property and the second trackable property comprise a same trackable property associated with the object of interest.

In an example embodiment, merging comprises updating a trackable property of the candidate object based on the first trackable property and the second trackable property.

In an example embodiment, merging comprises updating a semantic comprehension of the candidate object based on the updating of the trackable property.

In an example embodiment, the semantic comprehension comprises a confidence measure of the candidate object comprising the trackable property

In an example embodiment, the system may be further configured to promote the candidate object to a tracked object based on the semantic comprehension exceeding a semantic comprehension criteria.

According to an aspect, the present disclosure provides a system for tracking objects of interest in an environment, the system may include: a sensor; one or more processors, and a memory storing instructions thereon that, when executed by the one or more processors, configure the system to: maintain a collection of a plurality of tracked objects identified in the environment, the plurality of tracked objects each comprising: one or more trackable properties associated with an object of interest, and a tracked object location within the environment; acquire, from the sensor, a plurality of observations of the environment, each observation associated with a pose of the sensor for use in transforming between location coordinates in the plurality of observations and location coordinates in the environment; identify an object at a location within an observation of the plurality of observations, the object comprising a trackable property associated with the object of interest; transform, based on the sensor pose associated with the observation, the location of the object within the observation to a predicted location within the environment; determine a correspondence between the object and each of the plurality of tracked objects based on a distance between the predicted location within the environment and the tracked object location within the environment; identify the correspondence to a tracked object having the highest correspondence, and, based on the correspondence: merge the object with the tracked object, or register the object as a new candidate object for maintaining in a collection of candidate objects.

According to an aspect, the present disclosure provides a non-transitory computer-readable storage medium having instructions stored thereon that when executed by one or processors, cause the one or more processors to: acquire, from a sensor, a plurality of observations of the environment, each observation associated with a pose of the sensor for use in transforming between location coordinates in the plurality of observations and location coordinates in the environment; identify an object at a location within an observation of the plurality of observations; transform, based on the pose of the sensor associated with the observation, the location of the object within the observation to an object location within the environment, and identify the object in a different observation of the plurality of observations based on a correspondence between a location of the object within the different observation and the object location in the environment.

In an example embodiment, the instructions may further configure the one or more processors to identify the object in the observation based on a first trackable property associated with an object of interest, and identify the object in the different observation based on a second trackable property associated with the object of interest.

In an example embodiment, the instructions may further configure the one or more processors to associate each of the first trackable property and the second trackable property with the object location within the environment.

In an example embodiment, the first trackable property and the second trackable property comprise a same trackable property of the object of interest.

In an example embodiment, the instructions may further configure the one or more processors to update a semantic comprehension of the object based on at least one of the first trackable property, the second trackable property, and the location of the object within the different observation.

In an example embodiment, the instructions may further configure the one or more processors to determine a first observing perspective for the first tracked property and a second observing perspective for the second tracked property based on the sensor pose respectively associated with the observation and the different observation and the location of the object within the environment.

In an example embodiment, updating the semantic comprehension based on the first trackable property and/or the second trackable property is further based on determining a uniqueness of the first and second observing perspectives.

In an example embodiment, the instructions may further configure the one or more processors to maintain a collection of objects identified in the environment, the collection of objects comprising candidate objects and tracked objects.

In an example embodiment, the instructions may further configure the one or more processors to identify a tracked object in the collection of objects based on a tracked object correspondence.

In an example embodiment, the instructions may further configure the one or more processors to determine the tracked object correspondence based on a tracked object distance between the object and each of the tracked objects.

In an example embodiment, the tracked object distance comprises at least one of a Euclidean distance, a Manhattan distance, or a Minkowski distance, between the object location within the environment and a tracked object location within the environment.

In an example embodiment, the tracked object comprises the tracked object distance having a shortest distance to the object.

In an example embodiment, the instructions may further configure the one or more processors to determine a tracked property correspondence between the object and the tracked object, the tracked property correspondence based on correspondence between each of the first and second tracked property, and one or more tracked properties of the tracked object.

In an example embodiment, the instructions may further configure the one or more processors to merge the object with the tracked object based on a merging criteria.

In an example embodiment, the merging criteria comprises a maximum distance and wherein the shortest distance between the object and the tracked object is less than the maximum distance of the merging criteria.

In an example embodiment, the object does not meet the merging criteria, wherein the instructions further configure the one or more processors to register the object as a new candidate object in the collection of objects.

In an example embodiment, the instructions may further configure the one or more processors to identify a candidate object in the collection of objects based on a candidate object correspondence.

In an example embodiment, the instructions may further configure the one or more processors to determine the candidate object correspondence based on a candidate object distance between the object and each of the candidate objects.

In an example embodiment, the candidate object distance comprises at least one of a Euclidean distance, a Manhattan distance, or a Minkowski distance, between the object location within the environment and a candidate object location within the environment.

In an example embodiment, the candidate object comprises the candidate object distance having a shortest distance to the object.

In an example embodiment, the instructions may further configure the one or more processors to determine a candidate property correspondence between the object and the candidate object, the tracked property correspondence based on correspondence between each of the first and second tracked property, and one or more tracked properties of the candidate object.

In an example embodiment, the instructions may further configure the one or more processors to merge the object with the candidate object based on a merging criteria.

In an example embodiment, the merging criteria comprises a maximum distance and wherein the shortest distance between the object and the candidate object is less than the maximum distance of the merging criteria.

In an example embodiment, the instructions may further configure the one or more processors to promote the candidate object as a new tracked object in the collection of objects based on a promotion criteria.

In an example embodiment, the promotion criteria comprises a semantic comprehension threshold criteria.

In an example embodiment, the sensor comprises a range finder for determining a sensor-object distance between the sensor and the object.

According to an aspect, the present disclosure provides a non-transitory computer-readable storage medium having instructions stored thereon that when executed by one or processors, cause the one or more processors to: acquire, from a sensor, a plurality of observations of the environment, each observation associated with a pose of the sensor for use in transforming between location coordinates in the plurality of observations and location coordinates in the environment; identify a candidate object at a location within an observation of the plurality of observations based on a first trackable property associated with an object of interest; transform, based on the associated sensor pose, the location of the candidate object within the observation to a candidate object location within the environment; identify an object at a location within a different observation of the plurality of observations based on a second trackable property associated with the object of interest, and determine a correspondence between the location of the object within the different observation and the candidate object location within the environment and, based on the correspondence: merge the object with the candidate object, or disregard the object as the candidate object and register the object as a new candidate object.

In an example embodiment, merging comprises updating the candidate object location within the environment based on the location of the object in the different observation.

In an example embodiment, the first trackable property and the second trackable property comprise a same trackable property associated with the object of interest.

In an example embodiment, merging comprises updating a trackable property of the candidate object based on the first trackable property and the second trackable property.

In an example embodiment, merging comprises updating a semantic comprehension of the candidate object based on the updating of the trackable property.

In an example embodiment, the semantic comprehension comprises a confidence measure of the candidate object comprising the trackable property

In an example embodiment, the instructions may further configure the one or more processors to promote the candidate object to a tracked object based on the semantic comprehension exceeding a semantic comprehension criteria.

According to an aspect, the present disclosure provides a non-transitory computer-readable storage medium having instructions stored thereon that when executed by one or processors, cause the one or more processors to: maintain a collection of a plurality of tracked objects identified in the environment, the plurality of tracked objects each comprising: one or more trackable properties associated with an object of interest, and a tracked object location within the environment; acquire, from the sensor, a plurality of observations of the environment, each observation associated with a pose of the sensor for use in transforming between location coordinates in the plurality of observations and location coordinates in the environment; identify an object at a location within an observation of the plurality of observations, the object comprising a trackable property associated with the object of interest; transform, based on the sensor pose associated with the observation, the location of the object within the observation to a predicted location within the environment; determine a correspondence between the object and each of the plurality of tracked objects based on a distance between the predicted location within the environment and the tracked object location within the environment; identify the correspondence to a tracked object having the highest correspondence, and, based on the correspondence: merge the object with the tracked object, or register the object as a new candidate object for maintaining in a collection of candidate objects.

In an aspect, the present disclosure provides systems and methods for dynamic object comprehension which use spatial and temporal information to develop a semantic comprehension of objects and/or an environment, as may be leveraged for example by mixed-reality systems.

Systems and methods in accordance with the present disclosure include providing one or more sensors for use in generating data of a physical environment, for example by generating a plurality of observations of an environments, such as a plurality of 2D images. Some examples of sensors for generating a plurality of observations in accordance with the present disclosure include cameras, range finders, and LiDAR sensors. The sensor(s) may be integrated into existing devices, such as for example a camera integrated into a portable electronic device such as a mobile phone, tablet, or mixed-reality headset; such as for example one or more cameras integrated into a vehicle, such as an autonomous vehicle or autonomous car; such as for example one or more cameras integrated into a machine, such as a robot or robotic mechanism, such as a robotic arm in a manufacturing or assembly line, and so forth. The observations generated from the sensor(s) may further be associated with a pose of the sensor(s) for tracking the sensor(s) movement through the environment, such as may be accomplished using visual odometry and/or visual inertial odometry techniques. For example, the systems and methods in accordance with the present disclosure may include providing inertial sensors (e.g. accelerometers, gyroscopes, and magnetometers) for use in determining a pose of a camera associated with each image as the camera moves through the environment. Similarly, the systems and methods in accordance with the present disclosure may exploit knowledge of the environment or otherwise include a sensor, such as a range finder, for use in determining a distance to an object associated with each observation. The sensor pose information and/or distance information may be used to transform an observed location of an object within an observation to a location within the physical environment, and vice versa. Knowledge of the object's location in the environment may be leveraged to track and identify the object in other observations, improving semantic comprehension of the object over time and space based on the object's location.

Physical environment data may also be used to identify and/or confirm trackable properties of an object, which may further improve and/or model the semantic comprehension of an object. Trackable properties include, but are not limited to: a location of the object within the environment, a classification of an object, a type of object, a color of an object, a size of the object, an orientation of the object, a heat or infrared signature of the object, a surface characteristic of the object such as a matte finish, a gloss of the surface, a texture of the surface, a reflectivity of the surface or other light or image characteristic of the surface, a material of the object, and so forth. Embodiments in accordance with the present disclosure may further include providing a score, such as a comprehension score, having a value indicative of a level of semantic comprehension associated with an object. Higher level systems may interpret the score to determine whether it is confident about the semantic comprehension of the object. As an illustrative example, a mixed-reality system in accordance with the present disclosure may capture a plurality of images of a physical environment comprising a plurality of screws, nuts, bolts, and other miscellaneous hardware. As the system develops a semantic comprehension of items in the environment, it may further produce a comprehension score for each candidate object, for use in determining whether a particular piece of hardware has been found. For example, once the comprehension score for a particular candidate object exceeds a confidence threshold, the system may consider that the piece of hardware has been found or tracked, and may further add the piece of hardware to an inventory list comprising tracked objects.

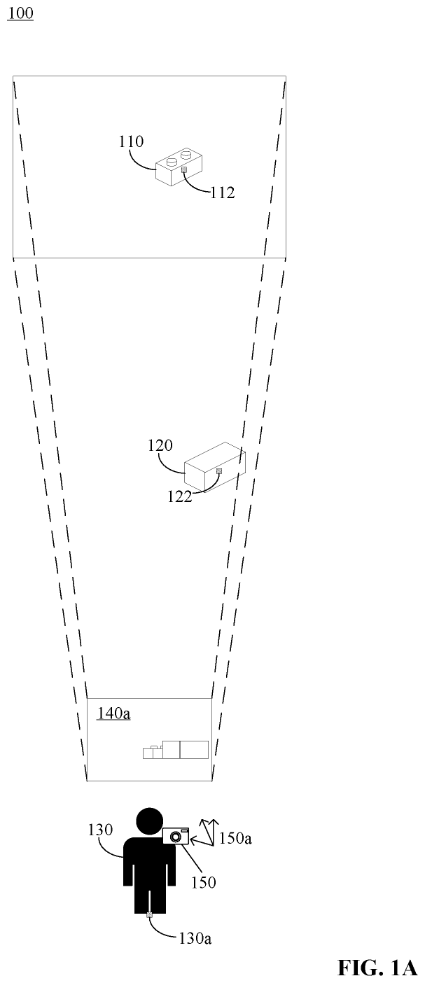

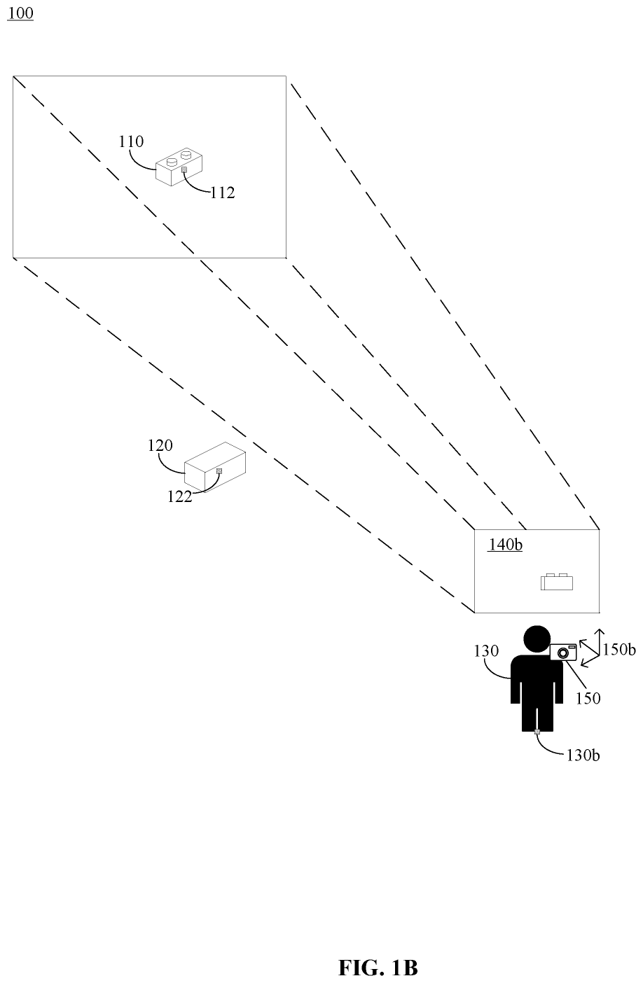

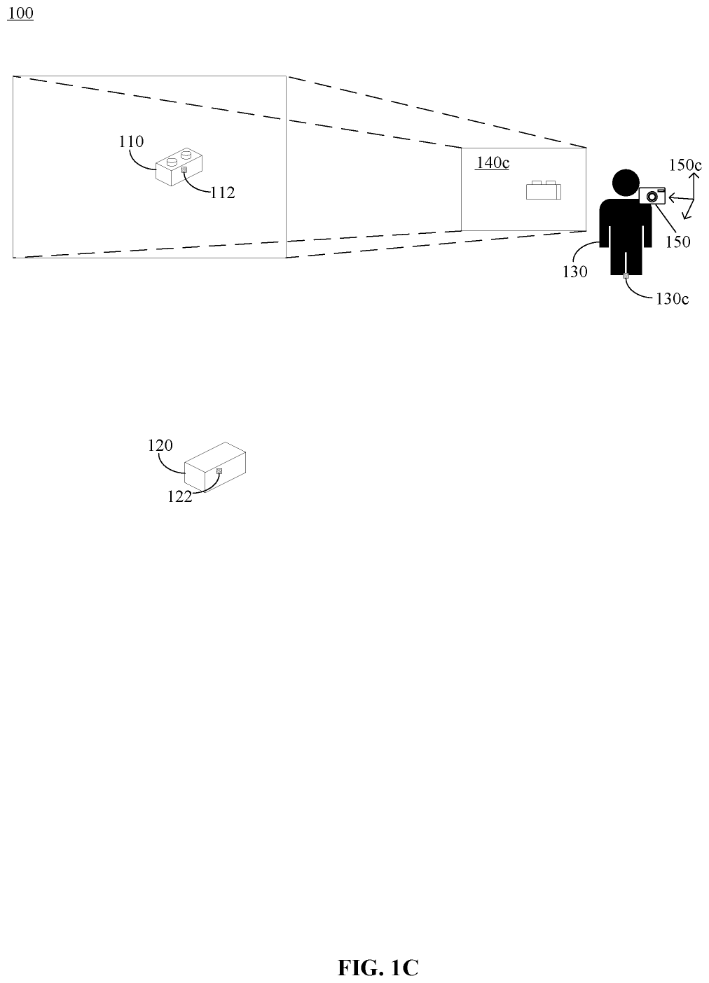

FIGS. 1A-1C illustrate a scene of an environment 100 comprising a first block 110 and a second block 120. The first block 110 is a rectangular block comprising two studs on a top surface and is disposed at a location 112 in the environment 100. The second block 120 is a plain rectangular block relatively larger than the first block 110, and is disposed at a location 122 in the environment 100. A person 130 moves about the environment 100 to first, second and third positions 130a, 130b, and 130c, respectively, to capture a plurality of observations 140a, 140b, and 140c, respectively, using a sensor system 150 comprising a camera and inertial sensors. Each of the observations 140a, 140b, and 140c, are associated with respective sensor orientation and position data 150a, 150b, and 150c, based on data generated by the inertial sensors of the sensor system 150 for each respective position 130a, 130b, and 130c. Each of the observations 140a, 140b, and 140c comprise 2D image data of the environment 100, as generated by a camera of the sensor system 150. In particular: observation 140a includes a 2D representation of the second block 120 occluding a portion of the first block 110, as seen by the sensor system 150 from location 130a with associated sensor orientation and position data 150a; observation 140b includes a 2D representation of the first block 110, as seen by the sensor system 150 from location 130b with associated sensor orientation and position data 150b; and, observation 140c includes a 2D representation of the first block 110 as seen by the sensor system 150 from location 130c with associated sensor orientation and position data 150c. Systems and methods in accordance with the present disclosure as further described herein may leverage the plurality of observations and associated sensor orientation and position data to determine a location of the object in the environment, for use in identifying and tracking objects in other observations.

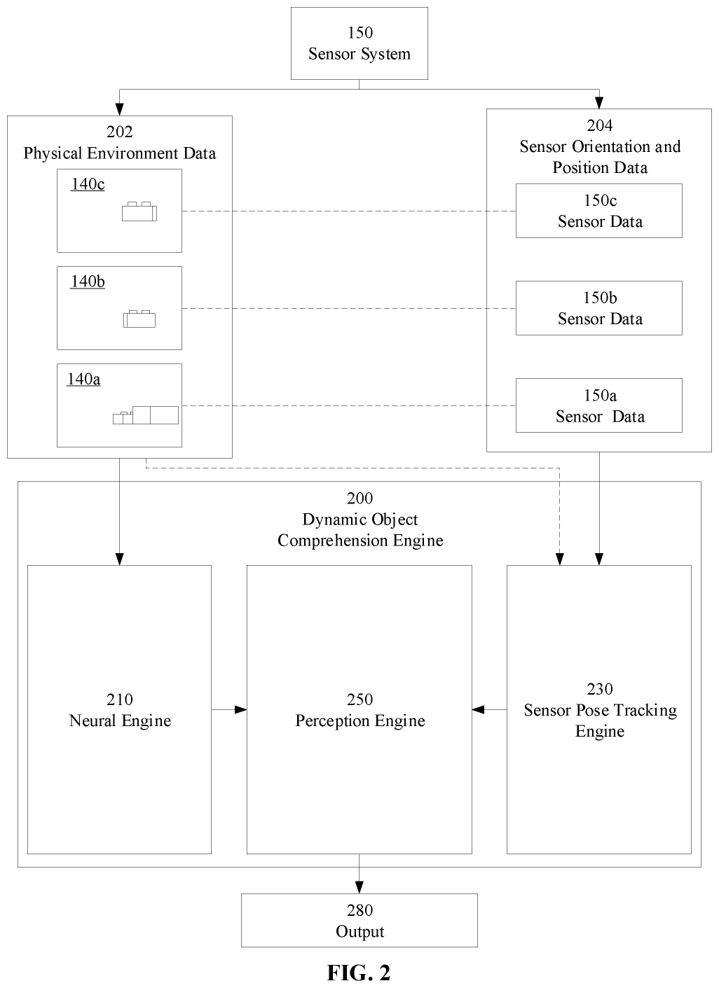

FIG. 2 illustrates an embodiment a dynamic object comprehension engine 200 in accordance with the present disclosure. A dynamic object comprehension engine 200 may be used to track one or more objects in an environment based on physical environment data and sensor orientation and position data. For example, the dynamic comprehension engine 200 may receive physical environment data 202 generated by a sensor system comprising a plurality of frame of physical environment data, such as the observations 140a, 140b, and 140c generated by the sensor system 150. The frame of physical environment data embodies a projection of the 3D environment onto the sensor(s). For example, a frame of physical environment data 202 may comprise 2D image data captured by a camera, such as an observation 140a, 140b, or 140c which represent a 3D projection of the environment 100 as projected onto the sensor system 150. Furthermore, the dynamic comprehension engine 200 may receive sensor orientation and position data 204 associated with physical environment data 202, such as the sensor orientation and position data 150a, 150b, and 150, respectively associated with the observations 140a, 140b, and 140c. The dynamic object comprehension engine 200 may use the physical environment data 202 and sensor orientation and position data 204 for tracking objects, such as the objects 110 and 120 in the environment 100. Embodiments of a dynamic object comprehension engine 200 may include a neural engine 210, sensor pose tracking engine 230, and perception engine 250, for use in generating a system output 280.

The dynamic object comprehension engine 200 may include a neural engine 210 for use in identifying an object in an observation and making predictions about the object based on the physical environment data 202. Neural engines in accordance with the present disclosure may be trained to make predictions regarding properties of an object, such as trackable properties or properties of interest, such as a class of an object, a type of object, a size of the object, a color of the object, and a location of the object. For example, the neural engine 210 may be configured to identify an object-of-interest in an observation and predict a location of the object within the observation. For further example, the neural engine 210 may receive the observation 140a and identify the two objects: the first block 110 and the second block 120. The neural engine 210 may further classify each object 110 and 120 as a block, in-particular, a type of studded block 110 and a type of non-studded block. The neural engine 210 may further predict a location of the first block 110 and a location of the second block 120 within the observation 140a. Embodiments of a neural engine 210 may be configured to consolidate predictions into a prediction frame. Embodiments of a neural engine 210 may be configured to output a prediction or prediction frame for each input data, for example, for each corresponding observation or for each frame or element of physical environment data 202. Embodiments of a neural engine in accordance with the present disclosure, may further comprise one or more engines or sub-components for use in outputting a prediction or prediction frame.

The dynamic comprehension engine 200 may include a sensor pose tracking engine 230 for use in determining a sensor pose or orientation and position of a sensor for further association with corresponding data captured by the sensor. For example, the sensor pose tracking engine 230 may receive sensor orientation and position data 204 for use in determining a sensor pose associated with the physical environment data 202. For example, the sensor pose tracking engine 230 may receive sensor orientation and position data 150a, 150b, and 150c, for use in determining a sensor pose associated with each observation 140a, 140b, and 140c, respectively. Embodiments of a sensor pose tracking engine 230 may determine a sensor pose based on applying visual odometry and/or visual inertial odometry techniques. Embodiments of a sensor pose tracking system in accordance with the present disclosure may also receive as input, physical environment data 202, such as a frame of physical environment data. Embodiments of a sensor pose tracking engine 230 may determine a sensor pose using visual features including, but not limited to, SIFT, ORB, or the dynamic comprehension engine's 200 tracked properties of an object as anchors. Systems and methods in accordance with the present disclosure may also receive a sensor pose from higher level systems.

The dynamic comprehension engine 200 may include a perception engine 250 for use in managing a collection of objects in the environment, such as a collection of candidate objects and a collection of tracked objects. Embodiments of a candidate object include objects or objects-of-interest which may potentially emerge as tracked objects after developing a sufficient level of semantic comprehension, for example when achieving a comprehension score which exceeds a confidence threshold. Candidate objects provide a form of noise rejection and filtering for spurious or incorrect predictions that may contribute to the incorrect emergence of a tracked object. Embodiments of a tracked object include objects considered found, having achieved a sufficient level of semantic comprehension, for example by having a comprehension score which exceeds a confidence threshold. In an embodiment, all tracked objects initially begin as candidate objects; and, a subset of candidate objects eventually promote to tracked objects. Embodiments of a perception engine 250 may be configured to provide an output 280 comprising a collection of objects tracked by the system including providing one or more of their associated properties, for example providing a location of the object and/or one or more tracked properties of the object. For example, the output 280 may comprise, tracked objects and/or candidate objects.

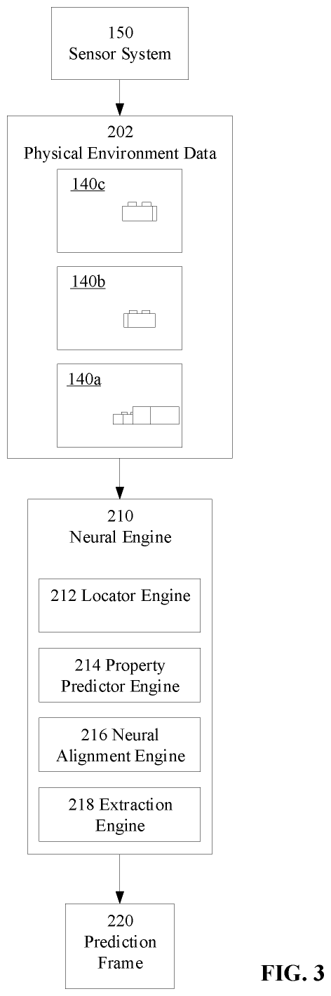

FIG. 3 illustrates an embodiment of a neural engine 210 in accordance with the present disclosure further comprising a locator engine 212, a property prediction engine 214, a neural alignment engine 216, and an extraction engine 218, for use in generating a prediction frame 220. Embodiments of a neural engine in accordance with the present disclosure may include one or more of a locator engine, a property prediction engine, a neural alignment engine, and an extraction engine. Embodiments of a neural engine in accordance with the present disclosure may include zero or more property prediction engines.

A locator engine 212 in accordance with the present disclosure may be configured to predict a location of an object within an observation. For example, the locator engine 212 may receive as an input, physical environment data 202, such as a frame of physical environment data, for use in predicting a location of an object in the physical environment data 202. In an embodiment, the locator engine 212 predicts an observed location of where the object appears in the frame of physical environment data. For example, an observed location may comprise a pixel location within a 2D image, such as the pixel location of an object captured in observations 140a, 140b, and 140c. In an embodiment the observed location of the object is a center of the projection of the object in the frame of physical environment data. The output of a locator engine 212 may be provided as a location prediction or location prediction frame corresponding to each frame of physical environment data. The location of an object within an observation may be further used to predict a location of the object within the environment, for use in tracking the object across a plurality of observations, as further disclosed herein.

Embodiments of a locator engine in accordance with the present disclosure may be implemented using a machine learning system trained to detect objects and/or predict locations of objects. Machine learning systems in accordance with the present disclosure may be implemented in numerous ways, including but not limited to, an artificial neural network, a recurrent neural network, a convolutional neural network, logistic regression, support vector machines, and so forth. In an embodiment, the locator engine may be implemented using a machine learning system, including but not limited to: an ambiguity-aware machine learning system as disclosed in U.S. application Ser. No. 17/378,603 SYSTEM AND METHOD FOR IDENTIFYING AND MITIGATING AMBIGUOUS DATA IN MACHINE LEARNING ARCHITECTURES, a scale selective machine learning architecture as disclosed in U.S. application Ser. No. 17/671,159 SCALE SELECTIVE MACHINE LEARNING SYSTEM AND METHOD, and a dimensionally aware neural network as disclosed in U.S. application Ser. No. 17/671,158 DIMENSIONALLY AWARE MACHINE LEARNING SYSTEM AND METHOD, the entirety of each application being herein incorporated by reference. Accordingly, the locator engine may be trained to receive an input, such as a frame of physical environment data, and further provide an output classifying whether an object or object of interest exists in a region or location of the input. In an embodiment, the locator engine may provide an output comprising a matrix wherein each element of the matrix corresponds to a region of an input, wherein each element includes a binary indication of whether an object or object of interest exists in that region.

A property prediction engine 214 in accordance with the present disclosure may be configured to predict a property of an object within an observation. For example, the property prediction engine 214 may receive as an input, physical environment data 202, such as a frame of physical environment data, for use in predicting a property of an object in the physical environment data 202, such as predicting a tracked property of an object of interest. Embodiments of a property prediction engine 214 may also receive as input, a subset of an input or frame of physical environment data. For example, an extraction engine 218 as further disclosed herein may provide the property prediction engine 214 with a subset of data for analysis, such as a swatch or cropping of a frame of physical environment data. The output of a property prediction engine 214 may be provided as a prediction or property prediction frame corresponding to each input or frame of physical environment data. Embodiments of a neural engine 210 in accordance with the present disclosure may include a property prediction engine 214 for each tracked property. For example, a neural engine 210 may be configured to track the class of an object, the type of object, and the color of an object, and may include first, second, and third property prediction engines for predicting each respective tracked property. For example, the set of property prediction engines may be trained to classify objects which are blocks and chess pieces; identify block class objects as a studded block or non-studded block; identify chess class objects as a pawn, rook, knight, bishop, queen, or knight; and further predict a color of the object, such as black or white for chess class objects, and so forth. Embodiments of property prediction engines may further provide an ambiguous prediction in accordance with the present disclosure. In an embodiment, a property prediction engine may comprise an ambiguity-aware machine learning system as disclosed in U.S. application Ser. No. 17/378,603 SYSTEM AND METHOD FOR IDENTIFYING AND MITIGATING AMBIGUOUS DATA IN MACHINE LEARNING ARCHITECTURES, the contents of which are herein incorporated by reference. Embodiments of a neural engine 210 in accordance with the present disclosure may include zero or more property predictor engines.

Embodiments of a property prediction engine in accordance with the present disclosure may be implemented using a machine learning system trained for image classification tasks and/or for detecting objects. Machine learning systems in accordance with the present disclosure may be implemented in numerous ways, including but not limited to, an artificial neural network, a recurrent neural network, a convolutional neural network, logistic regression, support vector machines, and so forth. In an embodiment, the locator engine may be implemented using a machine learning system, including but not limited to: an ambiguity-aware machine learning system as disclosed in U.S. application Ser. No. 17/378,603 SYSTEM AND METHOD FOR IDENTIFYING AND MITIGATING AMBIGUOUS DATA IN MACHINE LEARNING ARCHITECTURES, a scale selective machine learning architecture as disclosed in U.S. application Ser. No. 17/671,159 SCALE SELECTIVE MACHINE LEARNING SYSTEM AND METHOD, and a dimensionally aware neural network as disclosed in U.S. application Ser. No. 17/671,158 DIMENSIONALLY AWARE MACHINE LEARNING SYSTEM AND METHOD, the entirety of each application being herein incorporated by reference. Accordingly, a property prediction engine may be trained to receive an input, such as a frame of physical environment data, and further provide an output predicting whether a particular tracked property is present. For example, the property prediction engine may receive a frame of physical environment data and provide an output indicating whether an object or object of interest exists in a region or location of the input having a particular tracked property. In an embodiment, the property prediction engine may provide an output comprising a matrix wherein each element of the matrix corresponds to a region of an input, wherein each element includes a binary indication of whether an object or object of interest having the tracked property exists in that region.

A neural alignment engine 216 in accordance with the present disclosure may be configured to output a prediction or prediction frame 220 corresponding to the physical environment data, for example, a prediction frame 220 corresponding to each frame of physical environment data. In particular, a neural alignment engine 216 may be configured to receive a plurality of inputs, such as a location prediction (such as a location prediction frame output from a locator engine 212), and such as all property predictions (such as each property prediction frame output from each corresponding property predictor engine 214). The neural alignment engine 216 may consolidate all predictions into a single data structure to generate a prediction frame 220 comprising a plurality of predictions corresponding to the particular frame of physical environment data. Embodiments of a neural engine 210 in accordance with the present disclosure may for example implement a neural alignment engine 216 when also implementing more than one property prediction engine 214. Embodiments of a neural engine 210 in accordance with the present disclosure may not include a neural alignment engine 216.

An extraction engine 218 in accordance with the present disclosure may be configured to extract and output a subset of the physical environment data, for example, extracting and outputting a swatch or cropping of the input data. The extraction engine 218 may receive as an input, physical environment data 202, and a location prediction, for use in outputting a subset of physical environment data. For example, the extraction engine 218 may receive a frame of physical environment data, a location prediction frame from a locator engine 212, and may output a subset of the frame of physical environment data based on the location prediction, such as for example 2D image cropped based on the location prediction. Embodiments of an extraction engine 218 may organize a collection of outputs into a single image based on a compositing algorithm, for example, organizing a plurality of cropped 2D images into a single composite image. In an embodiment, the compositing algorithm may comprising tiling the individual cropped images in a grid like fashion.

An extraction engine 218 may crop physical environment data in accordance with existing image processing techniques, as may be further implemented by available hardware resources, such as available CPU resources and/or GPU resources configured to implement a cropping algorithm. Advantageously, the extraction engine 218 may reduce a size of input data to one or more property predictor engines 214, thereby reducing computation resources, providing improvements in real-time performance.

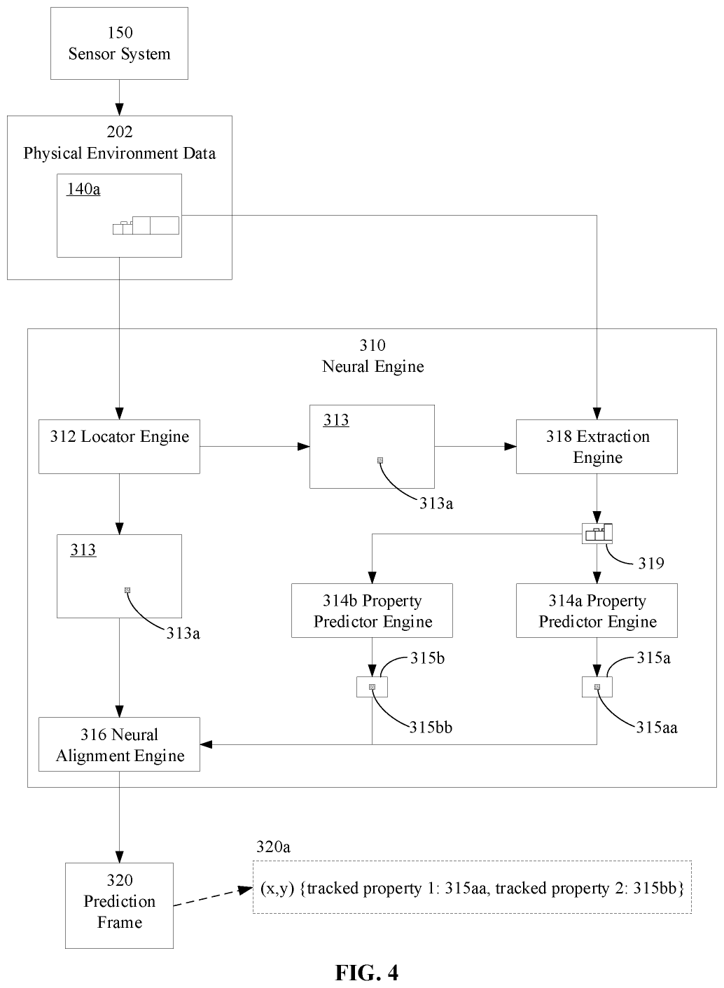

FIG. 4 provides an illustrative example of an embodiment of a neural engine in accordance with the present disclosure, such as the neural engine 210 illustrated in FIGS. 2 and 3. The neural engine 310 may be configured to output a prediction frame 320 based on an input comprising environment data 202. The neural engine 310 includes a locator engine 312, first and second property predictor engines 314a and 314b, neural alignment engine 316 and an extraction engine 318, each engine being in accordance with a corresponding element as described with respect to FIG. 3.

The locator engine 312 may be configured to output a prediction location frame 313 for identifying studded objects based on an input comprising physical environment data. In this particular example, the locator engine 312 receives a frame of physical environment data 202 comprising the observation 140a provided by the sensor system 150 as observed from the location 130A, as further illustrated in FIG. 1A. The observation 140a comprises a 2D image of the first block 110 and the second block 120. The locator engine 312 is configured to identify a studded object as an object of interest and non-studded objects may be disregarded. Based on the observation 140a, the locator engine 312 is able to output a location prediction frame 313 comprising the predicted location 313a of the studded block 110 in the observation 140a. The locator engine 312 further provides the location prediction frame 313 to the neural alignment engine 316 and the extraction engine 318. The predicted location 313a may be provided in a coordinate system consistent with the physical environment data. For example, the predicted location 313a may comprise (x,y) pixel coordinates for physical environment data comprising 2D images. In an embodiment, the location 313a may comprise a predicted center location of an object or object-of-interest.

The extraction engine 318 may be configured to output a subset of data 319 based on an input of physical environment data 202 and the prediction location frame 313. In this illustrative example, the extraction engine crops the observations 140a about an area corresponding to the predicted location 313a, to generate a subset of the observation 140a comprising the cropped image 319. In an embodiment, the extraction engine may crop to a fixed size, for example, a fixed size of pixels centered about the predicted location 313a. The extraction engine 318 further provides the cropped image 319 to each of the property predictor engines, namely the first property predictor engine 314a and the second property predictor engine 314b. The first and second property predictor engines 314a and 314b, respectively may each be configured to predict whether an input, such as a cropped image 319, comprises a particular tracked property. In an embodiment, the extraction engine outputs a subset of data for each corresponding location prediction in the prediction location frame 313.

The first property predictor engine 314a may be configured to predict a color of an object of interest, in particular, whether the studded object is white, based on the cropped image 319 provided by the extraction engine 318. The first property predictor engine 314a may provide the color prediction in a first property prediction frame 315a. In this illustrative example, the first property predictor engine 314a may output a property prediction frame 315a encoded with an indication of a white object of interest at a location 315aa corresponding to the object-of-interest in the cropped image 319. The first property predictor engine 314a may further provide the first property prediction frame 315a to the neural alignment engine 316.

The second property predictor engine 314b may be configured to track a number of studs on an object of interest, in particular, whether the studded object comprises exactly two studs, based on the cropped image 319 provided by the extraction engine 318. The second property predictor engine 314b may provide the number-of-studs prediction in a second property prediction frame 315b. In this illustrative example, the second property predictor engine 314b may output a property prediction frame 315b encoded with a null or ambiguous indication of the number of studs at a location 315bb corresponding to the object-of-interest in the cropped image 319. The null or ambiguous indication in this instance may result from the second block 120 occluding vision of the first block 110, making it indeterminate as to the number of studs the first block 110 may have when viewed only from the observation 140a. The second property predictor engine 314b may further provide the second property prediction frame 315b to the neural alignment engine 316.

The neural alignment engine 316 may be configured to generate a prediction frame 320 based on a plurality of predictions including the location prediction frame 313, the first property prediction frame 315a, and the second property prediction frame 315b. In an embodiment the prediction frame 320 may comprise a plurality of predictions consolidated to their respective predicted locations. In an embodiment, the prediction frame 320 may be modelled as a dictionary, comprising a plurality of dictionary entries or keys. In an embodiment, the entries or keys for the dictionary may comprise a predicted location, and the value for an entry or key may comprises the collection of property predictions provided by the property predictor engines. Thus, in this illustrative example, an entry or key 320a may correspond to the predicted location 313a encoded with values corresponding to the first property prediction frame 315a and the second property prediction frame 315b. Accordingly, the key may have a entry (x,y) corresponding to the pixel location of the predicted location 313a, and further comprise a first tracked property value “white” corresponding to the first prediction frame 315a and a second tracked property value “ambiguous” or “null” corresponding to the second prediction frame 315b. Thus a key in accordance with the illustrative example of FIG. 4 may include a location prediction encoded with a plurality of property predictions, for example a dictionary entry or key 320a comprising a white studded object at location (x,y) having an ambiguous number of studs.

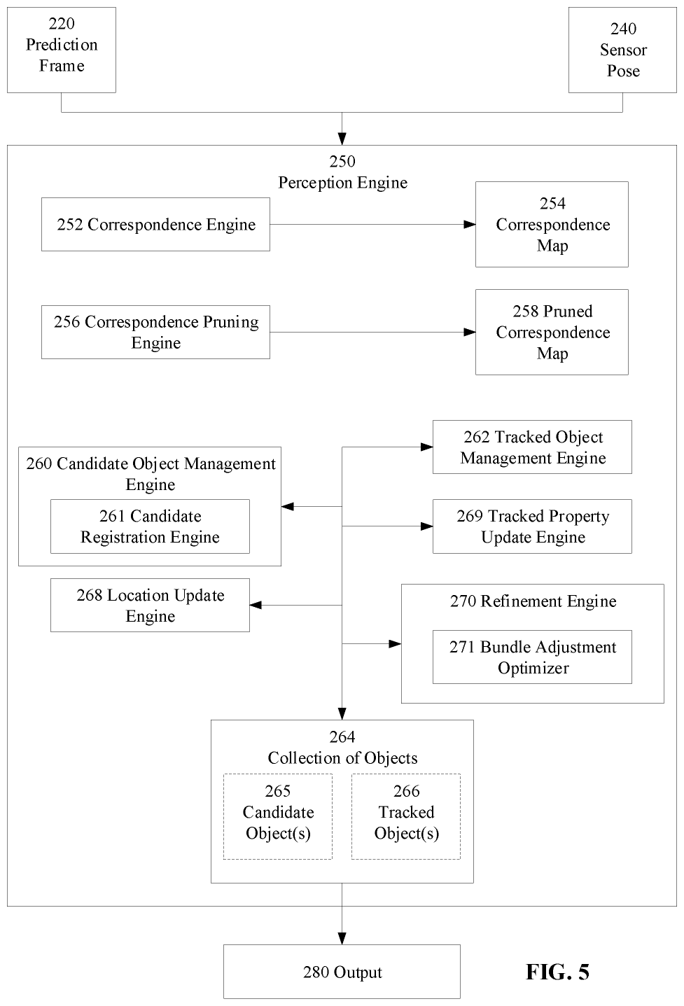

FIG. 5 illustrates an embodiment of a perception engine 250 in accordance with the present disclosure further comprising a correspondence engine 252, a correspondence pruning engine 256, a candidate object management engine 260, a tracked object management engine 262, and a position update engine 268, for use in generating an output 280. Embodiments of a perception engine 250 may further maintain a collection of objects 264 comprising objects in the environment, in particular tracked objects 266 and/or candidate objects 265.

A perception engine 250 in accordance with the present disclosure may be configured to manage a collection of objects in the environment, such as a collection of candidate objects and a collection of tracked objects in the environment. Embodiments of a candidate object include objects or objects-of-interest which may potentially emerge as tracked objects after developing a sufficient level of semantic comprehension, for example when achieving a comprehension score which exceeds a confidence threshold. Candidate objects provide a form of noise rejection and filtering for spurious or incorrect predictions that may contribute to the incorrect emergence of a tracked object. Embodiments of a tracked object include objects considered found, having achieved a sufficient level of semantic comprehension, for example by having a comprehension score which exceeds a confidence threshold. In an embodiment, all tracked objects initially begin as candidate objects; and, a subset of candidate objects eventually promote to tracked objects.

The perception engine 250 may receive as inputs, a prediction frame 220 as provided by the neural engine 210, and an associated sensor pose 240 as may be provided by the sensor pose tracking engine 230 or another system configured for determining a pose or orientation and position of a sensor. The perception engine 250 may leverage the prediction frame 220 and the sensor pose 240 to determine whether any objects or objects of interest identified in the prediction frame 220 correspond to an object in the collection of objects 264, such as previously identified candidate objects 265 or tracked objects 266. Prediction frames having predictions which are unassociated with an object in the collection of objects 264 may be considered for new candidate objects. The perception engine 250 may thus update the collection of objects 264 it manages based on the prediction frame 220 and the sensor pose 240. For example, the perception engine 250 may modify the collection of objects 264 by adding a new candidate object, promoting a candidate object to a tracked object, removing a candidate object or tracked object, and so forth. The perception engine 250 may further provide an output 280 based on the collection of objects 264. In an embodiment, the output 280 comprises one or more tracked objects 266. In an embodiment, the output 280 comprises one or more candidate objects 265 and one or more tracked objects 266.

A correspondence engine 252 in accordance with the present disclosure may be configured to identify correspondences between a frame of physical environment data and objects in the collection of objects 264. For example, the correspondence engine 252 may receive as inputs the collection of objects 264 and a prediction frame 220 corresponding to a frame of physical environment data, such as an observation 140a, 140b, or 140c. The correspondence engine 252 may determine whether the prediction frame 220 observed predictions of objects of interest corresponding to a tracked object 266 or a candidate object 265. Phrased differently, the correspondence engine 252 may assist in re-identification: associating objects observed in different frames as being the same object, in particular, whether an object observed in one frame is the same as a previously identified object observed in one or more other frames. Re-identification may include identifying correspondences in a plurality of observations in an unordered manner. For example, the last sequential observation in a plurality of observations may be used to identify a first observation of an object. Re-identification may further reveal one or more further observations of the object in an observation previous to the last sequential observation. Thus, any observation of the plurality of observations which identifies an object may serve as a first observation of the object wherein the first observation may provide a basis for re-identifying the object in one or more other observations whether occurring sequentially before or after the first observation.

Embodiments of a correspondence engine 252 may provide an output comprising a correspondence map 254 based on a predictions in a prediction frame and a type of object maintained by the collection of objects 264. For example the correspondence map may comprise a tracked correspondence map for correspondences with tracked objects 266. As another example, the correspondence map 254 may comprise a candidate correspondence map for correspondences with candidate objects 265. Embodiments of a correspondence engine 252 may determine a correspondence using a common coordinate space.

As an illustrative example, an embodiment of a correspondence engine 252 may be configured to generate a correspondence map 254 comprising a tracked correspondence map for tracked objects 266 in accordance with one or more rules, including one or more of the following example rules which may be similarly applied in a corresponding manner to generate a correspondence map 254 comprising a candidate correspondence map for candidate objects 265.

A rule for generating a tracked correspondence map may include that a prediction frame 220 comprising an entry having no correspondence to a tracked object in the collection of objects 264 may indicate that the entry is associated with an object or object of interest that the perception engine 250 does not presently track.

A rule for generating a tracked correspondence map may include that a prediction frame 220 comprising an entry having exactly one correspondence to a tracked object in the collection of objects 264 may indicate that the entry relates to tracked object that the perception engine 250 presently includes in the collection of objects 264.

A rule for generating a tracked correspondence map may include that an entry/prediction may not correspond to more than one tracked object in the collection of objects 264; it is not possible that one prediction is for two different objects.

A rule for generating a tracked correspondence map may include that a tracked object in the collection of objects 264 may have no correspondence to any entries in a given prediction frame 220, which may indicate that the tracked object was not observed in the corresponding frame of physical environment data for that prediction frame 220.

A rule for generating a tracked correspondence map may include that a tracked object in the collection of objects 264 may have exactly one correspondence to an entry in a given prediction frame 220, which may indicate that the tracked object was observed in the corresponding frame of physical environment data for that prediction frame.

A rule for generating a tracked correspondence map may include that a tracked object in the collection of objects 264 may not have correspondences to multiple entries. In an embodiment, a locator engine, such as the locator engine 212, may be configured to produce multiple location predictions for the same projection of an object or object of interest, precluding implementation of the sixth rule.

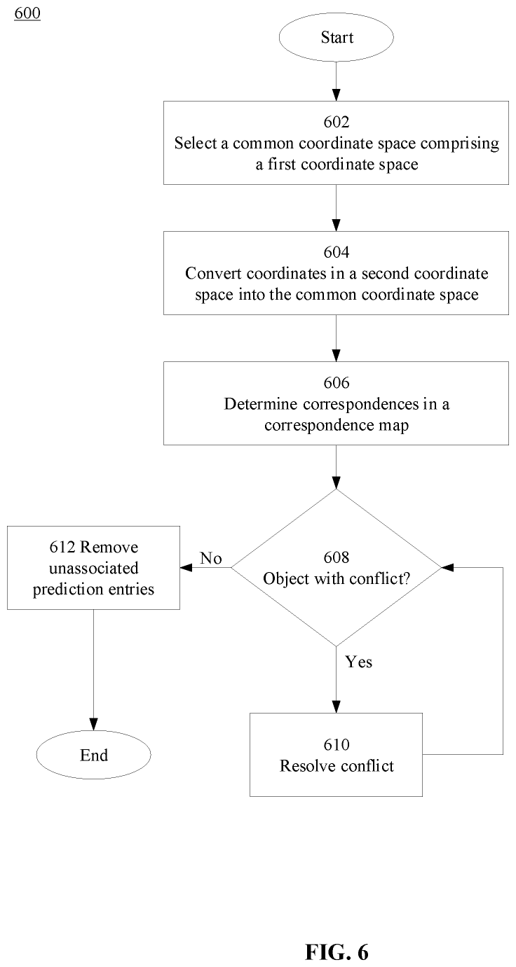

Embodiments of a correspondence engine 252 in accordance with the present disclosure may be configured to generate a correspondence map 254 in accordance with one or more steps, including with one or more of the steps provided in the example illustrated in FIG. 6.

FIG. 6 illustrates a method 600 for generating a correspondence map in accordance with an embodiment of the present disclosure. The operation of method 600 is not intended to be limiting but rather illustrates an example of generating a correspondence map. In some embodiments, the method 600 may be accomplished with one or more additional operations not described, and/or without one or more of the operations described. Similarly, the order in which the operation of method 600 is illustrated and described below is not intended to be limiting, but rather illustrative of an example of generating a correspondence map in accordance with an embodiment of the present disclosure.

In some embodiments, the method 600 may be implemented in one or more processing devices (e.g., a digital processor, an analog processor, a digital circuit designed to process information, an analog circuit designed to process information, a computing network implemented in the cloud, a state machine, and/or other mechanisms for electronically processing information). The one or more processing devices may include one or more devices executing some or all of the operations of the method 600 in response to instructions stored electronically on an electronic storage medium. The one or more processing devices may include one or more devices configured through hardware, firmware, and/or software to be specifically designed for execution of one or more of the operations of the method 600.

Embodiments of correspondence map 254 in accordance with the present disclosure may provide predictions and objects in a common coordinate system for use in determining associations and correspondences between the predictions and objects. A method 600 may include an operation 602 for identifying a first coordinate space as a common coordinate space, such as a coordinate space within the physical environment or a coordinate space within a frame of physical environment data or a prediction frame.

A method 600 may include an operation 604 for converting coordinates from a second coordinate space into the common coordinate space. As an illustrative example of an operation 604 for converting coordinates between different coordinates spaces: in a camera projection process, the 3D coordinates of objects tracked in the environment may be transformed into 2D image space using the following equation:

$${P}_{2 D} = K [ R \vert t ] {P}_{3 D}$$

where:
P_{3D} is the 3D position of the Tracked Object in the physical coordinate space,
P_{2D} is the 2D position of the Tracked Object in the image coordinate space,
K is the camera intrinsic matrix,
R is the orientation of the camera expressed as a rotation matrix, and
t is the position of the camera in 3D space as described by a translation vector.

The camera intrinsic matrix K is a known property of the sensor which acquired the image; and, the values R and t may be provided by the sensor pose 240, or otherwise derivable from sensor orientation and position data, or provided by another system. Similarly, transforming from 2D image space into 3D may be accomplished by determining a distance to the object and using an inverse of the above equation. Embodiments in accordance with the present disclosure may determine depth or distance to an object using one or more sensors, such as a range finder, such as a LIDAR sensor. Embodiments in accordance with the present disclosure may determine depth or distance to an object using a plurality of sensors to triangulate the object. Embodiments in accordance with the present disclosure may determine depth or distance to an object using a dimensionally aware machine learning system.

As a further illustrative example, an operation 602 may select a first coordinate space comprising the 2D image space of a prediction frame as the common coordinate space. Accordingly, an operation 604 may convert coordinates of objects in the collection of objects 264 from a second coordinate space comprising a 3D location in the physical environment to the first coordinate space of the prediction frame. In this regard, location predictions as may be provided in a 2D image space of a prediction frame and the 3D location of objects, such as tracked objects 266, may be provided in a common coordinate space of a correspondence map 254, for use in determining correspondences and associations between entries in the prediction frame and the tracked object(s) 266.

The method 600 may include an operation 606 for determining correspondences between predictions and objects. For example, an operation 606 may initialize a correspondence map based on operations 602 and 604, wherein entries in a prediction frame 220 and objects in the collection of objects 264 are provided in the selected common coordinate space of the correspondence map. For example, a correspondence map 254 comprising a tracked correspondence map may include the prediction entries with tracked objects 266, whereas a correspondence map 254 comprising a candidate correspondence map may include prediction entries with the candidate objects 265. As a further example, a candidate-tracked correspondence map may include candidate objects and tracked objects only.

The operation 606 may determine a correspondence or association between predictions and objects based on a correspondence criteria. In an embodiment, the correspondence criteria comprises a distance. In an embodiment the distance is based on determining at least one of a Euclidean distance, a Manhattan distance, or a Minkowski distance, between a prediction and an object. For example, an operation 606 may determine a correspondence between the coordinates of an entry in a prediction frame and the coordinates of an object based on a determining a Euclidean distance between the entry and object in a common coordinate space. For example, the operation 606 for a tracked correspondence map may determine a distance between the predicted location of an entry in a prediction frame 220 and a tracked object 266 having a location converted to a common coordinate space of the predicted location. In an embodiment, the operation 606 identifies the closest object to a prediction based on a Euclidean distance between the object and prediction. The operation 606 may thus initialize a correspondence map based on determining a closest object for each prediction, for example determining the closest tracked object for each prediction in a tracked correspondence map and determining the closest candidate object for each prediction in a candidate correspondence map. The operation 606 may produce a correspondence map having objects in conflict wherein the object corresponds or associates with more than one entry in a prediction frame.

The method 600 may include an operation 608 to identify whether any objects in the correspondence map are in conflict. For example, a tracked correspondence map may initialize with one or more tracked objects being associated with more than one entry in a prediction frame, bringing the tracked object into conflict. When a correspondence map includes an object in conflict, the method 600 may include a further operation 610 a resolution process for resolving the conflict.

The method 600 may include an operation 610 for resolving a conflicted object. The operation 610 may include a step of maintaining the correspondence to the prediction entry best satisfying the correspondence criteria. For example, the operation 610 may maintain the correspondence for an object to the prediction entry having the closest distance to the conflicted object including further marking the object as visited. The other prediction entries originally corresponding to the conflicted object may be removed from corresponding to the visited object and further marked as unassociated. The operation 610 may include a further step of associating the unassociated prediction entries to an unvisited object based on a correspondence criteria; and, the operations 608 and 610 may repeat until no unvisited objects remain and all conflicts are cleared. For example, the method 600 may repeat the operations 608 and 610 for a tracked correspondence map until all tracked objects 266 have been visited or otherwise until there are no unassociated prediction entries and no tracked object 266 corresponds to more than one prediction entry.

The method 600 may include an operation 612 for removing unassociated prediction entries from the correspondence map which remain after resolving all conflicts. Unassociated prediction entries removed from a tracked correspondence map may serve as a basis for generating a candidate correspondence map. Unassociated prediction entries removed from a tracked correspondence map may be further considered for merging with candidate objects or registering as new candidate objects, including making corresponding updates to the collection of objects 264. In an embodiment, the method 600 may generate a candidate correspondence map based on the set of unassociated prediction entries and the candidate objects 265. In an embodiment, the method 600 may generate a tracked correspondence map based on a prediction frame and the tracked objects 266. Embodiments of the method 600 in accordance with the present disclosure may concurrently generate a tracked correspondence map and a candidate correspondence map based on a prediction frame and the combined set of tracked objects 266 and candidate objects 265.

FIG. 5 further illustrates an embodiment of a correspondence pruning engine in accordance with the present disclosure. A correspondence pruning engine 256 may be configured to modify a correspondence map. For example, the correspondence pruning engine 256 may receive as an input, the prediction frame 220 and the correspondence map 254 generated by the correspondence engine 252 and may further provide a pruned correspondence map 258, which may eliminate zero or more correspondences in the correspondence map 254. For example, the pruning engine 256 may eliminate correspondences based on a pruning criteria. In an embodiment, a pruning criteria may comprise a threshold distance for use in eliminating correspondences having a distance greater than the threshold distance. For example, a correspondence may be based on a Euclidean distance between a predicted center location of an object in an image and a projected 2D position of a tracked object's location from within the 3D space in the physical environment. In an embodiment, the pruning criteria may comprise a function for comparing a property prediction provided in a prediction frame 220 to a tracked object's corresponding property value.

A candidate management engine 260 in accordance with the present disclosure may be configured to manage candidate objects, such as candidate objects 265 that may be maintained in the collection of objects 264. Embodiments of a candidate object include objects or objects-of-interest which may potentially emerge as tracked objects after developing a sufficient level of semantic comprehension, for example when achieving a comprehension score which exceeds a confidence threshold. Candidate objects provide a form of noise rejection and filtering for spurious or incorrect predictions that may contribute to the incorrect emergence of a tracked object. In an embodiment, all tracked objects initially begin as candidate objects; and, a subset (e.g. none, some, or all) of candidate objects may eventually promote to tracked objects.

The correspondence engine 252 may generate a candidate correspondence map in accordance with an embodiment of the present disclosure based on the set of unassociated prediction entries and the set of candidate objects 265 maintained in the collection of objects 264. In an embodiment, an unassociated observation is assumed to either correspond to an existing candidate object 265 or concern a new candidate object. Unassociated prediction entries which are thus determined to associate or correspond to an existing candidate object may be merged into the corresponding candidate object and the candidate management engine 260 may update the collection of objects 264 accordingly.

A candidate management engine 260 may receive as inputs, a prediction frame such as the prediction frame 220, and a correspondence map 254 comprising a tracked correspondence map of tracked objects 266. A candidate management process in accordance with the present disclosure may include one or more of the following steps:

A step of candidate object management may include identifying unassociated prediction entries in the prediction frame 220, for example, identifying any prediction entries in the prediction frame which do not have an association or correspondence to a tracked object 266 in the tracked correspondence map.

A step of candidate object management may include identifying whether an unassociated prediction entry may rather have an association or correspondence to an existing candidate object 265. Unassociated prediction entries determined to have correspondence to an existing candidate object 265 may be merged together. In an embodiment, the candidate object management engine 260 may merge an unassociated prediction entry with a candidate object 265 based on a merge criteria, including updating the collection of objects 264 accordingly. Merging an unassociated prediction entry with a candidate object 265 may include a step of updating a location of the candidate object based on a location associated with the merging prediction entry. Unassociated prediction entries determined to have no correspondence with an existing candidate object 265 may be considered as a new candidate object.

In an embodiment the candidate object management engine 260 may determine that the prediction entry does not meet the merge criteria with an existing candidate object 265, and the unassociated prediction entry may be considered as a new candidate object. In an embodiment, the candidate object management engine 260 may update the candidate objects 265 to include new candidate objects based on the set of unassociated prediction entries having no correspondence to an existing candidate object 265.

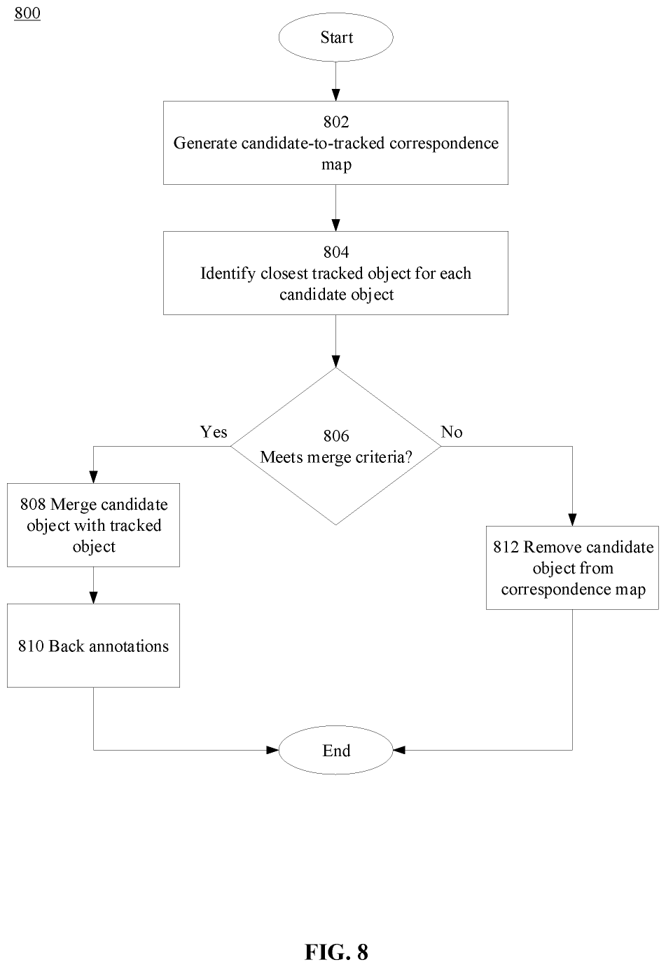

A step of candidate object management may include merging existing candidate objects 265 with existing tracked objects 266 based on a merging criteria. FIG. 8 provides an example of an embodiment of merging a candidate object 265 with an existing tracked object 266.

A step of candidate object management may include promoting a candidate object 265 to a tracked object 266 based on a promotion criteria. For example, candidate objects 265 which do not merge with a tracked object 266 may be further considered for promotion to a tracked object based on a promotion criteria. Embodiments of a promotion criteria in accordance with the present disclosure include exceeding a threshold number of observations of the candidate object; exceeding a semantic comprehension score threshold; and, determining whether one or more tracked properties associated with the candidate object exceed or match an associated tracked property threshold or criteria. Candidate objects which promote may be removed from the set of candidate objects 265 and added to the set of tracked objects 266 in the collection of objects 264.

A step of candidate object management may include purging a candidate object 265 from the collection of objects 264 based on a purging criteria. An embodiment of a purging criteria includes exceeding a duration since the candidate object was observed, for example exceeding a threshold number of frames between observations of the candidate object, for example a threshold number of frame of physical environment data. An embodiment of a purging criteria includes exceeding a duration since the candidate object was expected to be observed. For example, a perception engine 250 in accordance with the present disclosure may be able to leverage knowledge of a candidate object's location and the sensor pose to determine whether a candidate object should be visible from a given location. The candidate object management engine 260 may thus track a number of frames since the candidate object was last expected to be seen and may further purge the candidate object from the set of candidate objects 265 when exceeding a threshold number of frame since the last expected observation.

A candidate object management engine 260 may further comprise a candidate registration engine 261 for use in implementing a step of candidate object management including registering new candidate objects based on the subset of unassociated prediction entries which did not merge with existing candidate objects. Embodiments of a candidate registration engine 261 may receive as inputs, unassociated prediction entries of the prediction frame 220 and the corresponding sensor pose 240 associated with the prediction frame 220, for use in determining a location of the new candidate object and for registering tracked properties.

With reference to the illustrative example of FIG. 4, a step of candidate object management may determine that the prediction entry 320a is unassociated with a candidate object 265 and may proceed with registering the first block 110 as a new candidate object. A step of registering the first block 110 may include transforming a predicted location of the first block 110 in the observation 140a into a location 112 within the environment 100. For example, the candidate registration engine may use the (x,y) location prediction coordinates 313a encoded in the prediction entry 320a along with the associated sensor pose to determine a location 112 of the first block 110 in the environment 100. In an embodiment, the location 112 may comprise a projected center of the object. In an embodiment, the candidate registration engine 261 may determine the location 112 of the first block 110 in the environment 100 in accordance with one or methods and/or operations as disclosed herein, for example, in accordance with the operation 604. In an embodiment, the candidate registration engine 261 adds the first block 110 to the candidate objects 265 maintained in the collection of objects 264.

Embodiments of a candidate registration engine 261 may be configured to implement a step of registering a candidate object including initializing properties for tracking. With reference to the illustrative example of FIG. 4, the candidate registration engine 261 may initialize properties for tracking the first block 110 based on the tracked properties provided in the prediction entry 320a and the sensor pose associated with the prediction frame 320. Embodiments of a candidate registration engine may provide an output comprising a tracked property further comprising a property prediction and an associated sensor pose.

Embodiments of a perception engine 250 may comprise a location update engine 268 for use in updating a location of an object in the collection of objects 264. For example, the location update engine 268 may update the location of a candidate object 265 or a tracked object 266. The location update engine 268 may receive as inputs, a location prediction and an associated sensor pose. For example, the location update engine 268 may receive a location prediction for an object in a first coordinate space, for use in updating a location of the object in a second coordinate space. For example, the location update engine 268 may receive an (x,y) location prediction 313a for a first block 110 and an associated sensor pose for use in updating a location 112 of the first block in the environment 100. The location update engine 268 may receive the location prediction discretely, or for example embedded in a prediction entry of a prediction frame, such as the prediction entry 320a of the prediction frame 320. Embodiments of a location update engine 268 may be configured to transform coordinates between different coordinate space in accordance with one or more methods and/or operations as disclosed herein, for example, in accordance with the operation 604. In an embodiment, the location update engine 268 may apply a weighted average function to update a current location of an object based on a prediction location and one or more previously observed locations. Systems and methods in accordance with the present disclosure may improve a semantic comprehension of an object based on updating a location of an object.

Embodiments of a perception engine 250 may comprise a tracked property update engine 269 for use in updating a tracked property of an object in the collection of objects 264. For example, the tracked property update engine 269 may update the tracked property of a candidate object 265 or a tracked object 266. The tracked property update engine 269 may receive as inputs, a property prediction and an associated sensor pose. For example, the tracked property update engine 269 may receive a property prediction for an object in a first coordinate space, for use in updating a tracked property of the object in a second coordinate space. For example, the tracked property update engine 269 may receive an (x,y) property prediction 315aa and 315bb for a first block 110 and an associated sensor pose for use in updating one or more tracked properties of the first block 110 at the location 112 in the environment 100. The tracked property update engine 268 may receive the property prediction discretely, or for example embedded in a prediction entry of a prediction frame, such as the prediction entry 320a of the prediction frame 320. Embodiments of a tracked property update engine 269 may be configured to transform coordinates between different coordinate space in accordance with one or more methods and/or operations as disclosed herein, for example, in accordance with the operation 604. Embodiments of a tracked property update engine may update a tracked property based on an eligibility criteria. In an embodiment, an eligibility criteria may include a limit on a number of property predictions from an observing perspective, as further disclosed herein. Where a property prediction does not meet an eligibility criteria, the tracked property update engine 269 may disregard the property prediction. In an embodiment, a discarded property prediction may be stored in a buffer.

Systems and methods in accordance with the present disclosure may improve a semantic comprehension of an object based on updating one or more tracked properties of the object.

Systems and methods in accordance with the present disclosure may be configured to determine an observing perspective of a sensor relative to an object, for use in determining a semantic comprehension of an object. For example, determining a semantic comprehension for an object may include limiting or marginalizing the impact of observations from the same or relatively same observing perspective, to ensure that one or more observations from a particular area or region does not dominate the semantic comprehension of a given object. Considered from the perspective of sampling theory, each observation is a sampling of noisy data from an unknown distribution; accordingly, it may be beneficial to obtain a variety of different samples from the distribution to reconstruct the semantic comprehension of an object, without overweighting any one particular sample or samples of a particular region. Systems and methods in accordance with the present disclosure may determine a semantic comprehension for an object based on limiting the number of observations from an observing perspective that may be associated with a tracked property. In an embodiment, systems and methods may include a maximum number of observations per observing perspective.

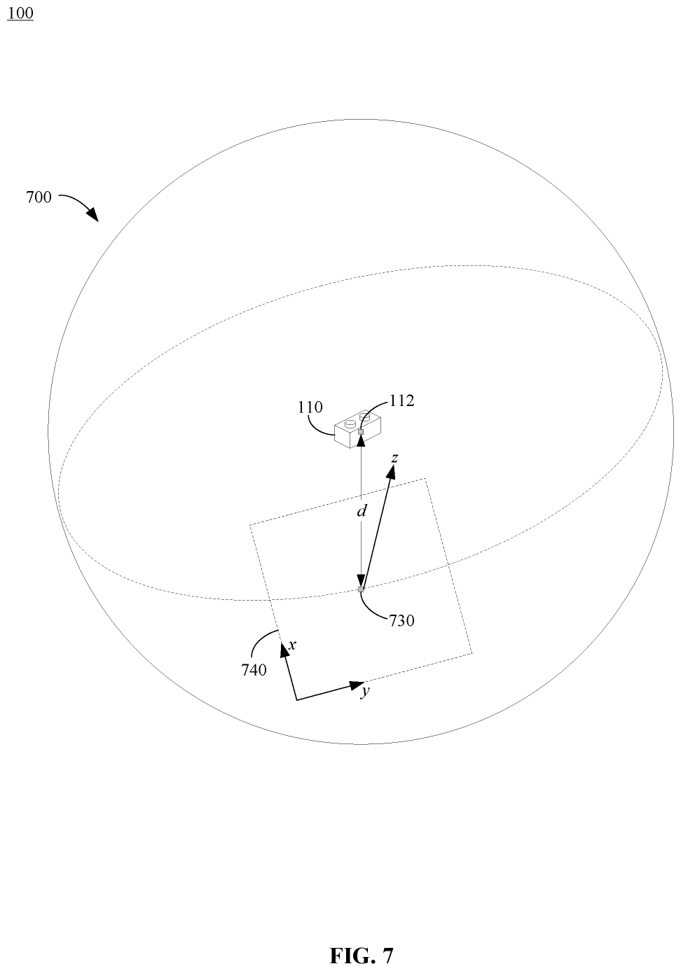

FIG. 7 provides an illustrative example of an observing perspective in accordance with the present disclosure. Embodiments of an observing perspective may comprise an observing distance, an observing longitude, and observing latitude, and an observing Z-rotation. An observing perspective may be generated based on an object's location within an environment, for example, based on the location 112 of the first block 110 in the environment 100. An observing perspective may comprise an observing distance, such as a Euclidean distance, corresponding to the distance d between an object and a sensor, such as the distance between the object location 112 and a location of the sensor system 150 as observed at the location 130a in FIG. 1A, further corresponding to the sensor observation location 730 in FIG. 7. The observing distance d may be used to determine an observing latitude and an observing longitude of the sensor system 150. For example, consider a sphere 700 centered about the object location 112, wherein the sphere has a radius corresponding to the observing distance d. Polar coordinates may be further applied to determine where on the sphere the sensor system 150 lies, for example, at the observing longitude and observing latitude corresponding to the sensor observation location 730. Determining an observing perspective may further comprise modelling the sensor system as a plane 740 tangential to the sphere 700 and further computing a rotation about the normal vector z to the plane 740 to determine an observing z-rotation.

In an embodiment values of the observing perspective are binned to a fixed resolution. In an embodiment, the bin size for the observing distance is referred to as the observing distance resolution. In an embodiment, the bin size for the observing longitude is referred to as the observing longitude resolution. In an embodiment, the bin size for the observing latitude is referred to as the observing latitude resolution. In an embodiment, the bin size for the observing Z-rotation is referred to as the observing Z-rotation resolution. As an illustrative example, the observing distance resolution may comprise 50 mm, the observing longitude resolution may comprise 1 degree, the observing latitude resolution may comprise 1 degree, and the observing Z-rotation may comprise 1 degree.

FIG. 8 illustrates a method 800 for merging a candidate object with a tracked object in accordance with an embodiment of the present disclosure. The operation of method 800 is not intended to be limiting but rather illustrates an example of merging a candidate object with a tracked object. In some embodiments, the method 800 may be accomplished with one or more additional operations not described, and/or without one or more of the operations described. Similarly, the order in which the operation of method 800 is illustrated and described below is not intended to be limiting, but rather illustrative of an example of merging a candidate object with a tracked object in accordance with an embodiment of the present disclosure.

In some embodiments, the method 800 may be implemented in one or more processing devices (e.g., a digital processor, an analog processor, a digital circuit designed to process information, an analog circuit designed to process information, a computing network implemented in the cloud, a state machine, and/or other mechanisms for electronically processing information). The one or more processing devices may include one or more devices executing some or all of the operations of the method 800 in response to instructions stored electronically on an electronic storage medium. The one or more processing devices may include one or more devices configured through hardware, firmware, and/or software to be specifically designed for execution of one or more of the operations of the method 800.

The method 802 may include an operation 802 for generating a correspondence map comprising a candidate-to-tracked correspondence map. For example, the operation 802 may include one or more operations of the method 600 for generating a correspondence map. In particular, generating a candidate-to-tracked correspondence map may include receiving as inputs, the candidate objects 265 and the tracked objects 266 maintained in the collection of objects 264, for use in determining an association or correspondence between the candidate objects 265 and the tracked objects 266 in a common coordinate space.

The method 800 may include an operation 804 for identifying the closest tracked object for each candidate object. The closest object may be based on determining a distance between the candidate object and the tracked object, such as a Euclidean distance between each object's location in a common coordinate space, such as each object's location in the physical environment. In an embodiment, a candidate object and the closest tracked object may be considered to have a preliminary correspondence.

The method 800 may include an operation 806 for applying a merging criteria to pairs of candidate objects and tracked objects having a preliminary correspondence. The merging criteria may be based on a threshold distance. For example, the merging criteria may comprise a maximum distance allowable between candidate objects and tracked objects, for example, a maximum distance between a location of the candidate object and the tracked object in the physical environment. Embodiments of a merging criteria may be adjusted depending on application and/or type of objects. For example, a merging criteria for applications with static objects may comprise a narrow limit on distances between the candidate object and tracked object. The method 800 may proceed to a further operation 808 or 812 depending on an outcome of the operation 806.

The method 800 may proceed to an operation 808 when a candidate-tracked object pair meets a merging criteria, as may be determined for example in accordance with an operation 806. The operation 808 may include adding the candidate object associated with the candidate-tracked object pair to the candidate-tracked correspondence map. Candidate objects remaining in the candidate-tracked correspondence map may be merged with their corresponding tracked object. Merging with a tracked object may include incorporating all predictions associated with the candidate object, such as the predictions provided in a prediction entry of a prediction frame, into the tracked object. Candidate objects merged with tracked objects may be further removed from the set of candidate objects 265 in the collection of objects 264.

The method 800 may proceed to an operation 810 for adding prediction entries to a previously generated tracked correspondence map. For example, a tracked correspondence map may not include the prediction entries corresponding to the candidate object that merged with the tracked object. Accordingly, an operation 810 may include visiting one or more candidate correspondence maps associated with the merged candidate object, and further remove the prediction entry correspondences associated with the merged candidate object from the correspondence map(s) and further add them to the corresponding tracked correspond map(s); in other words, the operation 810 may back annotate one or more tracked correspondence maps based on the candidate objects previous correspondences with prediction entries, as may be embodied in a candidate correspondence map.

The method 800 may proceed to an operation 812 when a candidate-tracked object pair does not meet a merging criteria, as may be determined for example in accordance with an operation 806. The operation 812 may include removing the candidate object associated with the candidate-tracked object pair from the candidate-tracked correspondence map. Candidate objects which do not merged with an existing tracked object may be further considered for promotion to a tracked object in accordance with the present disclosure.

FIG. 5 further illustrates a tracked object management engine 262 in accordance with an embodiment of the present disclosure. A tracked object management engine 262 may be configured to update a tracked property and/or a tracked objects 266 of the collection of objects 264. For example, the tracked object management engine 262 may be configured to: add corresponding prediction entries from a tracked correspondence map to the corresponding tracked property and/or tracked object; update a semantic comprehension score associated with the tracked property and/or the tracked object; and, purge tracked objects from the set of tracked objects 266.

Embodiments of a tracked object management engine 262 may be configured to implement a step of tracked object management, including purging a tracked object from the set of tracked objects 266 in the collection of objects 264. A step of purging may include assessing each tracked object against a purging criteria. An embodiment of a purging criteria includes exceeding a duration since the tracked object was expected to be observed. For example, a perception engine 250 in accordance with the present disclosure may be able to leverage knowledge of a tracked object's location and the sensor pose to determine whether a tracked object should be visible from a given location. The tracked object management engine 262 may thus track a number of frames since the tracked object was last expected to be seen and may further purge the tracked object from the set of tracked objects 266 when exceeding a threshold number of frames since the last expected observation of the tracked object.

In an embodiment, the purging criteria may be modified in accordance with an occlusion algorithm. For example, a tracked object may be occluded in a frame where the tracked object is expected to be visible but-for the occlusion. For example, a hand or other human body part may be occluding a line of sight from the sensor to the tracked object, thereby the tracked object may not be visible to the sensor. Accordingly, the tracked object management engine 262 may apply an occlusion algorithm, such as a body-detection algorithm or hand-tracking algorithm, for use in detecting an occlusion of an otherwise expected to be visible tracked object. Thus, while the tracked management engine 262 detects an occlusion of the tracked object, the tracked object management engine 262 may not increase the number of frames since the last expected observation of the tracked object. However, after removal of the occlusion, the tracked object management engine 262 may determine whether the tracked object is again visible or may otherwise proceed to again increase frames since the last expected observation of the tracked object if it is not visible.

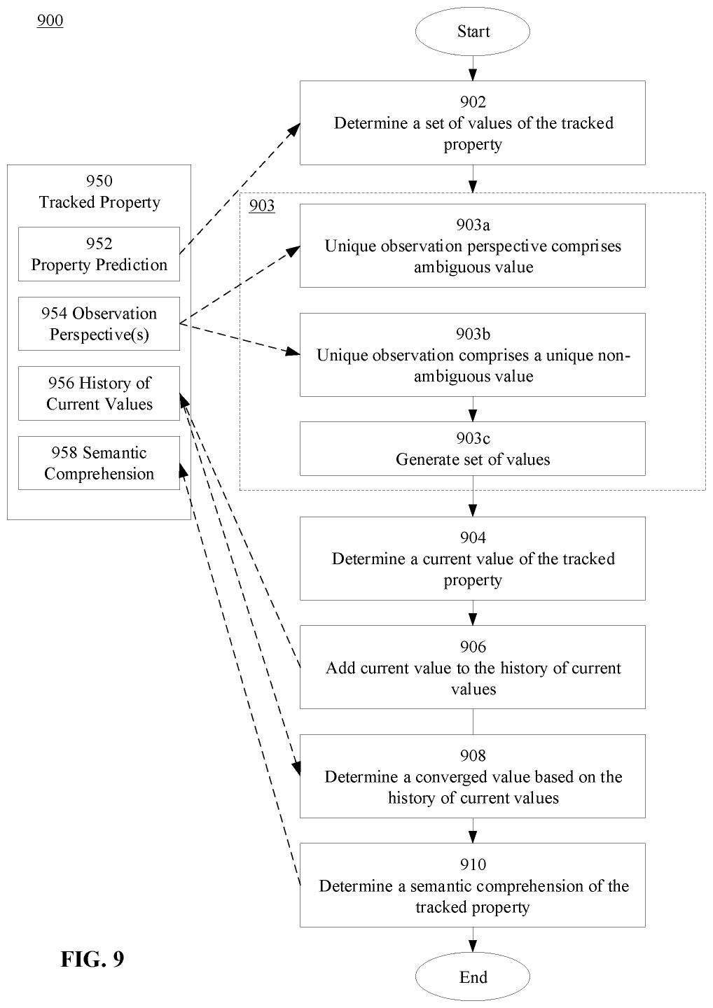

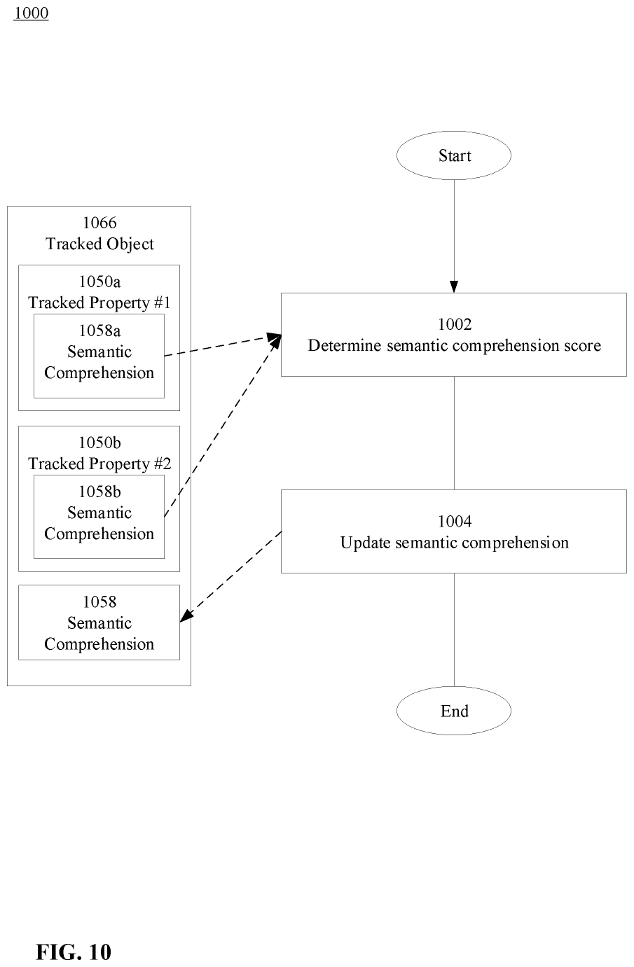

Embodiments of a tracked object management engine 262 may be configured to implement a step of tracked object management, including updating a tracked object, for example, providing new prediction entries associated with the tracked object to the location update engine 268 and/or tracked property update engine 269, for use in updating a location and/or tracked property of the tracked object 266 as disclosed herein. FIG. 9 further provides an illustrative example of updating a tracked property of a tracked object; and, FIG. 10 further provides an illustrative example of updating a tracked object.

FIG. 9 illustrates a data structure for a tracked property 950 and a method 900 for updating a tracked property. The operation of the method 900 is not intended to be limiting but rather illustrates an example of updating a tracked property. In some embodiments, the method 900 may be accomplished with one or more additional operations not described, and/or without one or more of the operations described. Similarly, the order in which the operation of the method 900 is illustrated and described below is not intended to be limiting, but rather illustrative of an example of updating a tracked property in accordance with an embodiment of the present disclosure.

In some embodiments, the method 900 may be implemented in one or more processing devices (e.g., a digital processor, an analog processor, a digital circuit designed to process information, an analog circuit designed to process information, a computing network implemented in the cloud, a state machine, and/or other mechanisms for electronically processing information). The one or more processing devices may include one or more devices executing some or all of the operations of the method 900 in response to instructions stored electronically on an electronic storage medium. The one or more processing devices may include one or more devices configured through hardware, firmware, and/or software to be specifically designed for execution of one or more of the operations of the method 900.

The method 900 may update the semantic comprehension of the tracked property 950 associated with an object, such as a tracked property associated with a candidate object or tracked object. The tracked property 950 may include a property prediction 952, observing perspective(s) 954, a history of current values 956, and a semantic comprehension 958. Embodiments of a property prediction 952 include a property prediction as may be generated by a property prediction engine, such as the property prediction engine 952. Embodiments of an observing perspective include an observing perspective comprising an observing distance, an observing latitude, an observing longitude, and an observing Z-rotation.

The method 900 may include an operation 902 for determining a set of values of the tracked property 950. The operation 902 may be triggered when a property prediction 952 is added to a tracked property 950, such as for example, when a property prediction from a frame of physical environment data is added to a tracked property. For example, an operation 902 may update a tracked property for the first block 110 corresponding to the observation 140a in response to property predictions arising from further other observations of the first block, such as the observations 140b and 140c. Accordingly, the operation 902 may trigger an update to a tracked property of the first block 110 in response to a prediction frame corresponding to the observations 140b and/or 140c.

In order to determine a set of values, the operation 902 may comprise a sub operation 903 for considering the set of property predictions for each unique observing perspective having at least one property prediction. In an embodiment, the number of property predictions for a unique observing perspective may not exceed a maximum limit of observations. The sub-operation 903 may include collapsing the set of property predictions for a unique observing perspective into a single value.

The sub-operation 903 may include an operation 903a for collapsing the set of property predictions to correspond to an ambiguous value. The operation 903a may occur based on an indication that the unique observing perspective may not provide reliable predictions; in other words, that the unique observing perspective may be unreliable. For example, the operation 903a may occur if one or more property predictions for a unique observing perspective is ambiguous. Similarly, the operation 903a may occurs if there are two or more non-ambiguous property predictions, possibly indicating conflicting and unreliable predictions.

The sub-operation 903 may include an operation 903b for collapsing the set of property predictions to correspond to a unique value, for example, when the set of property predictions for a unique observing perspective comprises one unique non-ambiguous property prediction, indicating that observations from that particular unique observing perspective were likely reliable.

The sub-operation 903 may include an operation 903c for collecting the output of the operation 903b, for generating a set of values for the tracked property comprising the set of non-ambiguous collapsed property prediction values.

The method 900 may include an operation 904 for determining a current value of the tracked property 950 based on the set of values generated by operation 902. In an embodiment, the operation 904 may set the current value of the tracked property to ambiguous when the set of values comprises a number of entries below a threshold number, indicating that the set of values may lack non-ambiguous values from a sufficient number of different observing perspectives. In an embodiment, the operation 904 may set the current value of the tracked property to the most frequently occurring value in the set of values. In an embodiment, if the most frequently occurring value occurs less than a threshold number, then the operation 904 may set the current value of the tracked property to ambiguous, indicating there may be a lack of confidence.

The method 900 may include an operation 906 for adding the current value to the history of current values 956 of the tracked property 950.

The method 900 may include an operation 908 for determining a converged value of the tracked property 950 based on the history of current values 956. In an embodiment, the operation 908 may set the converged value of the tracked property to ambiguous when the history of current values 956 comprises a number of entries below a threshold number, indicating that the tracked property may not have been observed a sufficient number of times. In an embodiment the operation 908 may set the converged value of the tracked property to ambiguous when the history of current values 956 comprises different values, possibly indicating conflicting observations. The operation 908 may set the converged value of the tracked property to a non-ambiguous value corresponding to a value in the history of current values 256 when they are all the same.

The method 900 may include an operation 910 for determining a semantic comprehension 958 of the tracked property. The operation 910 may deem the semantic comprehension 958 of the tracked property 950 complete when the converged value comprises a non-ambiguous value. The operation 910 may deem the semantic comprehension 958 of the tracked property 950 incomplete when the converged value comprises an ambiguous value. Tracked properties having a complete semantic comprehension 958 may not necessarily add/receive further observations to add to the tracked property. Tracked properties having an incomplete semantic comprehension 958 may be further updated based on further observations.

FIG. 10 illustrates a data structure for a tracked object 1066 and a method 1000 for updating a tracked property. The operation of the method 1000 is not intended to be limiting but rather illustrates an example of updating a tracked object. In some embodiments, the method 1000 may be accomplished with one or more additional operations not described, and/or without one or more of the operations described. Similarly, the order in which the operation of the method 1000 is illustrated and described below is not intended to be limiting, but rather illustrative of an example of updating a tracked object in accordance with an embodiment of the present disclosure.

In some embodiments, the method 1000 may be implemented in one or more processing devices (e.g., a digital processor, an analog processor, a digital circuit designed to process information, an analog circuit designed to process information, a computing network implemented in the cloud, a state machine, and/or other mechanisms for electronically processing information). The one or more processing devices may include one or more devices executing some or all of the operations of the method 1000 in response to instructions stored electronically on an electronic storage medium. The one or more processing devices may include one or more devices configured through hardware, firmware, and/or software to be specifically designed for execution of one or more of the operations of the method 1000.

The method 1000 may update the semantic comprehension associated with a tracked object, such as the semantic comprehension of a tracked object 266 maintained in the collection of objects 264. FIG. 10 in particular illustrates updating the semantic comprehension 1058 of a tracked object 1066 comprising respective first and second tracked properties 1050a and 1050b. The first and second tracked properties 1050a and 1050b may be based on one or more embodiments of the present disclosure, such as the example of a tracked property 950 illustrated with FIG. 9. The first and second tracked properties 1050a and 1050b each include a respective first and second semantic comprehension 1058a and 1058b.

The method 1000 may include an operation 1002 for determining a semantic comprehension score of a tracked object, such as the semantic comprehension score of the semantic comprehension 1058 of the tracked object 1066. The operation 1002 may be trigged by an update to a tracked property, such as an update to a tracked property in accordance with the method 900 and one or more of its operations. As illustrated, in FIG. 10, the operation 1002 evaluates the first and second semantic comprehension 1058a and 1058b corresponding to respective first and second tracked properties 1050a and 1050b of the tracked object 1066, for use in determining a semantic comprehension 1058 of the tracked object 1066. Embodiments of an operation 1002 may determine a semantic comprehension score comprising a complete indication, an incomplete indication, and/or a comprehension score. For example, each of the first and second semantic comprehension 1058a and 1058b may comprise a complete indication or a max score. Accordingly, the operation 1002 may determine a corresponding semantic comprehension score for the semantic comprehension 1058 of the tracked object 1066, for example a complete or max comprehension score.

As a further example, each of the first and second semantic comprehension 1058a and 1058b may be incomplete and/or comprise a non-max score. Accordingly the operation 1002 may assign a corresponding semantic comprehension score to the semantic comprehension 1058 of the tracked object 1066 comprising an incomplete and/or non-max score.

As a further illustrative example, the first semantic comprehension 1058a may comprise a complete or max score and the second semantic comprehension 1058b may comprise an incomplete or non max score. The operation 1002 may determine the semantic comprehension score of the semantic comprehension 1058 as a function of these values. In an embodiment, the operation 1002 may apply a function, such as a weighted function, to the plurality of semantic comprehension scores of the respective plurality of tracked properties. For example, a first semantic comprehension 1058a may comprise a complete indication corresponding to a max score of 100 and a second semantic comprehension 1058b may comprise an incomplete indication corresponding to a score of 0. The operation 1002 may thus apply an equal-weight function to the respective first and second semantic comprehension 1058a and 1058b to produce a semantic comprehension score 50 for the tracked object 1066. The comprehension score may be further evaluated against a comprehension score criteria, for use in updating the semantic comprehension 1058 of the tracked object 1066.

The method 1000 may include an operation 1004 for updating the semantic comprehension 1058 of the tracked object 1066. In an embodiment, the operation 1004 updates the semantic comprehension 1058 to comprise a complete indication or an incomplete indication based on a corresponding outcome from the operation 1002. In an embodiment, the operation 1004 may evaluate a comprehension score provided by the operation 1002 against a comprehension score criteria. In an embodiment, the comprehension score criteria may require an indication of at least 75% of tracked properties deemed complete, for example at least 3 out of 4 tracked properties for a tracked object having four properties. As a further illustrative example, the operation 1004 may receive a comprehension score of 50 from an operation 1002, corresponding to 50% of the tracked properties being deemed complete. The operation 1004 may evaluate the score of 50 against the comprehension score criteria and update the semantic comprehension score accordingly. In this instance, a comprehension score criteria of 75 may result in the semantic comprehension 1058 of the tracked object 1066 being marked incomplete or with a corresponding score of 50. Embodiments of a perception engine 250 in accordance with the present disclosure may provide an output 280 only the set of tracked objects 266 having a complete semantic comprehension or a comprehension score which meets a comprehension score criteria.

FIG. 5 further illustrates a temporal refinement position engine 270 in accordance with an embodiment of the present disclosure. The refinement engine 270 may be configured to improve an accuracy of an object' locations after a prediction frame 220 has been processed by the perception engine 250. Embodiments of a refinement engine 270 configured to improve the accuracy of a predicted location for a tracked object may be configured to: maintain a sequential history of prediction frames of the tracked object; maintain the corresponding sensor poses associated with the sequential history of the prediction frames; and, maintain the corresponding observation-to-tracked correspondence maps associated with the prediction frame and the associated sensor poses, for use in improving an accuracy of a location of the tracked object. Embodiments of an observation-to-tracked correspondence map include a tracked correspondence map including a tracked correspondence map having back annotations resulting from a merged candidate object.

Embodiments of a refinement engine 270 may be configured to resolve a structure-from-motion problem, wherein one or more objects are observed in 3D space from a set of 2D projected images, wherein solving the structure-from-motion problem comprises determining the 3D position of the one or more objects and the associated sensor orientation and position data and/or sensor pose of the camera(s) used to capture the 2D projected images. In an embodiment, the one or more objects comprises a tracked object, the 3D position comprises a location of the tracked object within a physical environment, the 2D projected images comprises a plurality of observations of the tracked object, and the sensor orientation and position data and/or sensor pose comprises the sensor pose of the sensor system used to generate the plurality of observations. In an embodiment, the refinement engine 270 may apply an iterative algorithm to resolve the structure-from-motion problem. For example, the refinement engine 270 may iteratively refine an initial or first prediction of a location of the object in 3D space, for example an initial predicted location of the tracked object within the physical environment, based on further location predictions of the object in 3D space and associated sensor pose data.

Embodiments of a refinement engine 270 may be configured to implement a bundle adjustment optimizer 271 to assist in resolving the structure-from-motion problem. The bundle adjustment optimizer 271 may be configured to solve the structure-from-motion problem for a tracked object 266 in the collection of objects 264 based on the history of prediction frames for the tracked object, the history of sensor poses associated with the history of prediction frames, and the history of observation-to-tracked correspondence maps associated with the history of prediction frames wherein a location of the tracked object within the environment is an optimizable parameter. In an embodiment, the associated history of sensor pose data may be configured as a constant or as an optimizable parameters based on a reliability associated with the sensor pose. In an embodiment, the bundle adjustment optimizer 271 may apply a bounding to the tracked object's location within the environment, wherein the bound comprises an expected error margin. In an embodiment, the error margin may be determined based on a sensor limitation, for example, a resolution limitation of a camera or other sensor, such as a LIDAR sensor. In an embodiment, the error margin may be determined in accordance with a dimensionally aware neural network depth estimation or resolution estimation. The bundle adjustment optimizer 271 may consider that each predicted location provided in the history of prediction frames for a tracked object is considered the observed projection of the corresponding location of the tracked object in the physical environment according to the associated observation-to-tracked correspondence map. The bundle adjustment optimizer 271 may further update the location of the tracked object within the physical environment based on the outcome of the optimization. Based on available hardware resources, embodiments of a bundle adjustment optimizer may be configured to run in parallel with other systems, methods and operations as disclosed herein, and/or may be configured to run on a subset of frames of physical environment data, and/or further update the location of the tracked object within the environment at less frequency intervals.

In an embodiment, the bundle adjustment optimizer 271 may consider a subset of the tracked object's locations within the physical environment to comprise a constant wherein the subset of locations converge based on a convergence criteria. A convergence criteria may comprise whether a recent change in location falls below a threshold.

Embodiments of a refinement engine 270 may bound a size of the history for a tracked object, for example, the size of the history of prediction frames, the size of the associated sensor pose history, and the size of the history of the observation-to-tracked correspondence maps. Advantageously, bounding the size of the inputs may reduce the number of constraints for the bundle adjustment optimizer 271, providing significant improvements in run-time performance. Furthermore, bounding the size of the history for a tracked object may reduce memory requirements for storing the information. Further still, bounding the size of history may restrict the data from growing indefinitely in an unbounded fashion.

In an embodiment, the refinement engine 270 may bound the history for a tracked object based on applying a temporal window to the data history. For example, the refinement engine 270 may define a temporal window of one frame for defining a temporal history of a tracked object comprising one prediction frame, the sensor pose associated with the one prediction frame, and the observation-to-tracked correspondence map associated with the one prediction frame. Accordingly, the refinement engine 270 may define a temporal history of the tracked object based on the temporal window.

The refinement engine 270 may further consider an observation keyframe comprising only a subset of all possible temporal histories of the tracked object wherein the refinement engine only stores the observation keyframe. In an embodiment, the subset of all possible temporal histories is selected based on a selection criteria.

In an embodiment, the refinement engine 270 may define a selection criteria comprising a threshold number of correspondences. For example, a temporal history may be added to the observation keyframe wherein the observation-to-tracked correspondence map(s) associated with the temporal history include a number of correspondences which exceed the threshold number.

In an embodiment, the refinement engine 270 may initially include all temporal histories of the tracked object in the observation keyframe, and further apply a culling criteria for removing temporal histories from the observation keyframe. The culling criteria may be applied, for example, at regular intervals, such as for example when the number of temporal histories in the observation keyframe exceeds a threshold number. In an embodiment, the culling criteria may comprise applying a clustering algorithm to the observation keyframe to identify and cull redundant temporal histories of the tracked object. For example, the culling criteria may operate on the sensor pose to determine a similarity of a sensor pose between different temporal histories. Where a plurality of temporal histories have the same or similar sensor pose, one temporal history may remain in the observation keyframe and the other temporal histories may be removed for redundancy.

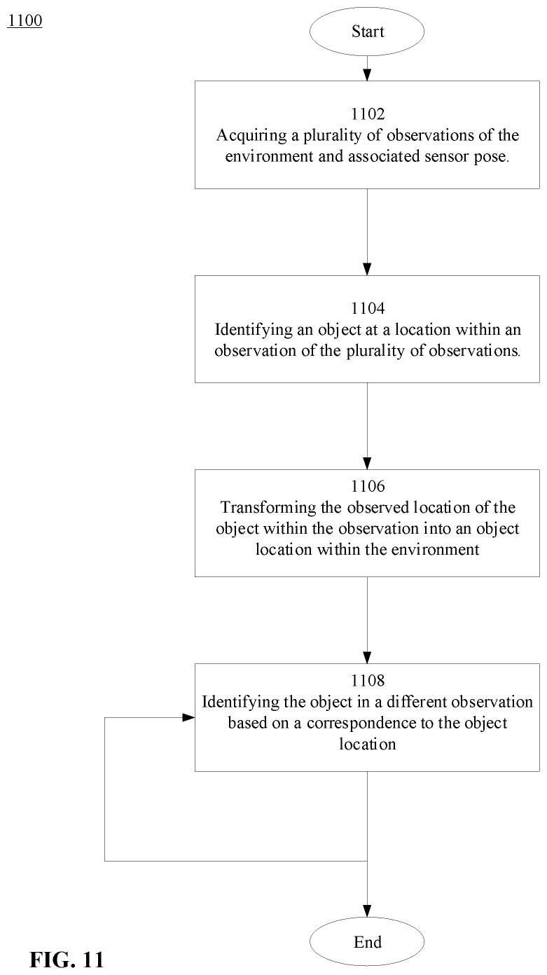

FIG. 11 illustrates a method 1100 for tracking objects of interest. The operation of the method 1100 is not intended to be limiting but rather illustrates an example of tracking objects of interest. In some embodiments, the method 1100 may be accomplished with one or more additional operations not described, and/or without one or more of the operations described. Similarly, the order in which the operation of the method 1100 is illustrated and described below is not intended to be limiting, but rather illustrative of an example of tracking objects of interest in accordance with an embodiment of the present disclosure.

In some embodiments, the method 1100 may be implemented in one or more processing devices (e.g., a digital processor, an analog processor, a digital circuit designed to process information, an analog circuit designed to process information, a computing network implemented in the cloud, a state machine, and/or other mechanisms for electronically processing information). The one or more processing devices may include one or more devices executing some or all of the operations of the method 1100 in response to instructions stored electronically on an electronic storage medium. The one or more processing devices may include one or more devices configured through hardware, firmware, and/or software to be specifically designed for execution of one or more of the operations of the method 900.

The method 1100 may be configured for tracking objects of interest in an environment. The method 1100 may include an operation 1102 for acquiring, using a sensor system, a plurality of observations of an environment, wherein each observation is associated with a sensor pose of the sensor system, for use in transforming between location coordinates in the plurality of observations and location coordinates in the environment. Embodiments of a sensor system in accordance with the present disclosure may comprise a camera wherein the observation comprises a 2D image project of the environment as seen from the camera.

The method may include an operation 1104 for identifying an object at an object location within an observation of the plurality of observations. Embodiments of an operation 1104 may further identify the object in the observation based on a trackable property associated with an object of interest.

The method may include an operation 1106 for transforming, based on the pose of the sensor associated with the observation, the location of the object within the observation to an object location within the environment. An operation 1106 may be performed, in accordance with one or more methods or operations as disclosed herein, for example, in accordance with the method 600 and/or one or more operations thereof include for example operations 602 and 604.

The method may include an operation 1108 for identifying the object in a different observation of the plurality of observations based on a correspondence between a location of the object within the different observation and the object location in the environment. Embodiments of the operation 1108 may further identify the object in the different observation based on a trackable property associated with an object of interest. The trackable property may for example be the same trackable property identified by an operation 1104 or may for example be different trackable property associated with an object of interest that was not identified by an operation 1104. The operation 1108 may be performed in accordance with one or more methods or operations as disclosed herein.

Embodiments of the method 1100 may include repeating one or more operations to improve a semantic comprehension of the object. For example, the method 1100 may repeat the operation 1108 to identify the object in a plurality of other observations, for improving a semantic comprehension of the object in accordance with the present disclosure.

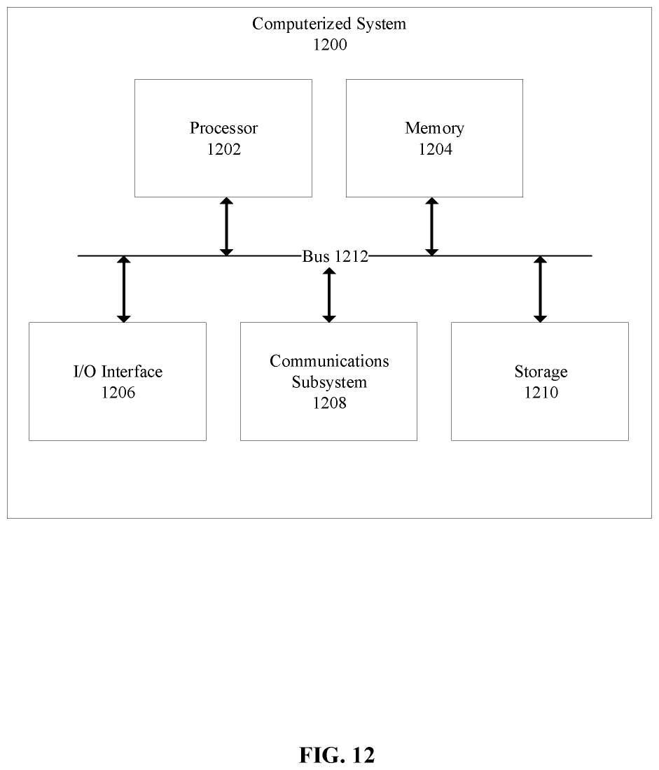

FIG. 12 is a block diagram of an example computerized device or system 1200 that may be used in implementing one or more aspects, components, sub-components, operations, and so forth, of embodiments of a system and method in accordance with the present disclosure.

Computerized system 1200 may include one or more of a processor 1202, memory 1204, a mass storage device 1210, an input/output (I/O) interface 1206, and a communications subsystem 1208. Further, system 1200 may comprise multiples, for example multiple processors 1202, and/or multiple memories 1204, etc. Processor 1202 may comprise one or more of a digital processor, an analog processor, a digital circuit designed to process information, an analog circuit designed to process information, a state machine, and/or other mechanisms for electronically processing information. These processing units may be physically located within the same device, or the processor 1202 may represent processing functionality of a plurality of devices operating in coordination. The processor 1202 may be configured to execute modules by software; hardware; firmware; some combination of software, hardware, and/or firmware; and/or other mechanisms for configuring processing capabilities on the processor 1202, or to otherwise perform the functionality attributed to the module and may include one or more physical processors during execution of processor readable instructions, the processor readable instructions, circuitry, hardware, storage media, or any other components.

One or more of the components or subsystems of computerized system 1200 may be interconnected by way of one or more buses 1212 or in any other suitable manner.

The bus 1212 may be one or more of any type of several bus architectures including a memory bus, storage bus, memory controller bus, peripheral bus, or the like. The CPU 1202 may comprise any type of electronic data processor. The memory 1204 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 1210 may comprise any type of storage device configured to store data, programs, and other information and to make the data, programs, and other information accessible via the bus 1212. The mass storage device 1210 may comprise one or more of a solid state drive, hard disk drive, a magnetic disk drive, an optical disk drive, or the like. In some embodiments, data, programs, or other information may be stored remotely, for example in the cloud. Computerized system 1200 may send or receive information to the remote storage in any suitable way, including via communications subsystem 1208 over a network or other data communication medium.

The I/O interface 1206 may provide interfaces for enabling wired and/or wireless communications between computerized system 1200 and one or more other devices or systems. For instance, I/O interface 1206 may be used to communicatively couple with sensors, such as cameras or video cameras. Furthermore, additional or fewer interfaces may be utilized. For example, one or more serial interfaces such as Universal Serial Bus (USB) (not shown) may be provided.

Computerized system 1200 may be used to configure, operate, control, monitor, sense, and/or adjust devices, systems, and/or methods according to the present disclosure.

A communications subsystem 1208 may be provided for one or both of transmitting and receiving signals over any form or medium of digital data communication, including a communication network. Examples of communication networks include a local area network (LAN), a wide area network (WAN), an inter-network such as the Internet, and peer-to-peer networks such as ad hoc peer-to-peer networks. Communications subsystem 1208 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1394), Thunderbolt™, WiFi™ (e.g. IEEE 802.11), WIMAX (e.g. IEEE 802.16), Bluetooth™, or Near-field communications (NFC), as well as GPRS, UMTS, LTE, LTE-A, and dedicated short range communication (DSRC). Communication subsystem 1208 may include one or more ports or other components (not shown) for one or more wired connections. Additionally or alternatively, communication subsystem 1208 may include one or more transmitters, receivers, and/or antenna elements (none of which are shown).

Computerized system 1200 of FIG. 12 is merely an example and is not meant to be limiting. Various embodiments may utilize some or all of the components shown or described. Some embodiments may use other components not shown or described but known to persons skilled in the art.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A method for tracking objects of interest in an environment, comprising:
acquiring, from a sensor, a plurality of observations of the environment, each observation associated with a pose of the sensor for use in transforming between location coordinates in the plurality of observations and location coordinates in the environment;
identifying an object at a location within an observation of the plurality of observations;
transforming, based on the pose of the sensor associated with the observation, the location of the object within the observation to an object location within the environment, and
identifying the object in a different observation of the plurality of observations based on a correspondence between a location of the object within the different observation and the object location in the environment.

2. The method according to claim 1, further comprising:
identifying the object in the observation based on a first trackable property associated with an object of interest, and
identifying the object in the different observation based on a second trackable property associated with the object of interest.

3. The method according to claim 2, further comprising, associating each of the first trackable property and the second trackable property with the object location within the environment.

4. The method according to claim 2, wherein the first trackable property and the second trackable property comprise a same trackable property of the object of interest.

5. The method according to claim 2, further comprising updating a semantic comprehension of the object based on at least one of the first trackable property, the second trackable property, and the location of the object within the different observation.

6. The method according to claim 5, further comprising determining a first observing perspective for the first tracked property and a second observing perspective for the second tracked property based on the sensor pose respectively associated with the observation and the different observation and the location of the object within the environment.

7. The method according to claim 6, wherein updating the semantic comprehension based on the first trackable property and/or the second trackable property is further based on determining a uniqueness of the first and second observing perspectives.

8. The method according to claim 2, further comprising maintaining a collection of objects identified in the environment, the collection of objects comprising candidate objects and tracked objects.

9. The method according to claim 8, further comprising identifying a tracked object in the collection of objects based on a tracked object correspondence.

10. The method according to claim 9, further comprising determining the tracked object correspondence based on a tracked object distance between the object and each of the tracked objects.

11. The method according to claim 10, wherein the tracked object distance comprises at least one of a Euclidean distance, a Manhattan distance, or a Minkowski distance, between the object location within the environment and a tracked object location within the environment.

12. The method according to claim 10, wherein the tracked object comprises the tracked object distance having a shortest distance to the object.

13. The method according to claim 8, further comprising determining a tracked property correspondence between the object and the tracked object, the tracked property correspondence based on correspondence between each of the first and second tracked property, and one or more tracked properties of the tracked object.

14. The method according to claim 12, further comprising merging the object with the tracked object based on a merging criteria.

15. The method according to claim 14, wherein the merging criteria comprises a maximum distance and wherein the shortest distance between the object and the tracked object is less than the maximum distance of the merging criteria.

16. The method according to claim 14, wherein the object does not meet the merging criteria, the method further comprising registering the object as a new candidate object in the collection of objects.

17. The method according to claim 8, further comprising identifying a candidate object in the collection of objects based on a candidate object correspondence.

18. The method according to claim 17, further comprising determining the candidate object correspondence based on a candidate object distance between the object and each of the candidate objects.

19. The method according to claim 18, wherein the candidate object distance comprises at least one of a Euclidean distance, a Manhattan distance, or a Minkowski distance, between the object location within the environment and a candidate object location within the environment.

20. The method according to claim 18, wherein the candidate object comprises the candidate object distance having a shortest distance to the object.

21. The method according to claim 17, further comprising determining a candidate property correspondence between the object and the candidate object, the tracked property correspondence based on correspondence between each of the first and second tracked property, and one or more tracked properties of the candidate object.

22. The method according to claim 20, further comprising merging the object with the candidate object based on a merging criteria.

23. The method according to claim 22, wherein the merging criteria comprises a maximum distance and wherein the shortest distance between the object and the candidate object is less than the maximum distance of the merging criteria.

24. The method according to claim 17, further comprising promoting the candidate object as a new tracked object in the collection of objects based on a promotion criteria.

25. The method according to claim 24, wherein the promotion criteria comprises a semantic comprehension threshold criteria.

26. The method according to claim 1, wherein the sensor comprises a range finder for determining a sensor-object distance between the sensor and the object.

27. A method for tracking objects of interest in an environment, comprising:
acquiring, from a sensor, a plurality of observations of the environment, each observation associated with a pose of the sensor for use in transforming between location coordinates in the plurality of observations and location coordinates in the environment;
identifying a candidate object at a location within an observation of the plurality of observations based on a first trackable property associated with an object of interest;
transforming, based on the associated sensor pose, the location of the candidate object within the observation to a candidate object location within the environment;
identifying an object at a location within a different observation of the plurality of observations based on a second trackable property associated with the object of interest, and
determining a correspondence between the location of the object within the different observation and the candidate object location within the environment and, based on the correspondence:
merging the object with the candidate object, or
disregarding the object as the candidate object and registering the object as a new candidate object.

28. The method according to claim 27, wherein merging comprises updating the candidate object location within the environment based on the location of the object in the different observation.

29. The method according to claim 27, wherein the first trackable property and the second trackable property comprise a same trackable property associated with the object of interest.

30. The method according to claim 27, wherein merging comprises updating a trackable property of the candidate object based on the first trackable property and the second trackable property.

31. The method according to claim 30, wherein merging comprises updating a semantic comprehension of the candidate object based on the updating of the trackable property.

32. The method according to claim 31, wherein the semantic comprehension comprises a confidence measure of the candidate object comprising the trackable property

33. The method according to claim 31, further comprising promoting the candidate object to a tracked object based on the semantic comprehension exceeding a semantic comprehension criteria.

34. A method for tracking objects of interest in an environment, comprising:
maintaining a collection of a plurality of tracked objects identified in the environment, the plurality of tracked objects each comprising:
one or more trackable properties associated with an object of interest, and
a tracked object location within the environment;
acquiring, from a sensor, a plurality of observations of the environment, each observation associated with a pose of the sensor for use in transforming between location coordinates in the plurality of observations and location coordinates in the environment;
identifying an object at a location within an observation of the plurality of observations, the object comprising a trackable property associated with the object of interest;
transforming, based on the associated sensor pose, the location of the object within the observation to a predicted location within the environment;
determining a correspondence between the object and each of the plurality of tracked objects based on a distance between the predicted location within the environment and the tracked object location within the environment;
identifying the correspondence to a tracked object having the highest correspondence, and, based on the correspondence:
merging the object with the tracked object, or
registering the object as a new candidate object for maintaining in a collection of candidate objects.

35. A system for tracking objects of interest in an environment, the system comprising:
a sensor;
one or more processors, and
a memory storing instructions thereon that, when executed by the one or more processors, configure the system to:
acquire, from the sensor, a plurality of observations of the environment, each observation associated with a pose of the sensor for use in transforming between location coordinates in the plurality of observations and location coordinates in the environment;
identify an object at a location within an observation of the plurality of observations;
transform, based on the pose of the sensor associated with the observation, the location of the object within the observation to an object location within the environment, and
identify the object in a different observation of the plurality of observations based on a correspondence between a location of the object within the different observation and the object location in the environment.

36. The system according to claim 35, further configured to:
identify the object in the observation based on a first trackable property associated with an object of interest, and
identify the object in the different observation based on a second trackable property associated with the object of interest.

37. The system according to claim 36, further configured to associate each of the first trackable property and the second trackable property with the object location within the environment.

38. The system according to claim 36, wherein the first trackable property and the second trackable property comprise a same trackable property of the object of interest.

39. The system according to claim 36, further configured to update a semantic comprehension of the object based on at least one of the first trackable property, the second trackable property, and the location of the object within the different observation.

40. The system according to claim 39, further configured to determine a first observing perspective for the first tracked property and a second observing perspective for the second tracked property based on the sensor pose respectively associated with the observation and the different observation and the location of the object within the environment.

41. The system according to claim 40, wherein updating the semantic comprehension based on the first trackable property and/or the second trackable property is further based on determining a uniqueness of the first and second observing perspectives.

42. The system according to claim 36, further configured to maintain a collection of objects identified in the environment, the collection of objects comprising candidate objects and tracked objects.

43. The system according to claim 42, further configured to identify a tracked object in the collection of objects based on a tracked object correspondence.

44. The system according to claim 43, further configured to determine the tracked object correspondence based on a tracked object distance between the object and each of the tracked objects.

45. The system according to claim 44, wherein the tracked object distance comprises at least one of a Euclidean distance, a Manhattan distance, or a Minkowski distance, between the object location within the environment and a tracked object location within the environment.

46. The system according to claim 44, wherein the tracked object comprises the tracked object distance having a shortest distance to the object.

47. The system according to claim 42, further configured to determine a tracked property correspondence between the object and the tracked object, the tracked property correspondence based on correspondence between each of the first and second tracked property, and one or more tracked properties of the tracked object.

48. The system according to claim 46, further configured to merge the object with the tracked object based on a merging criteria.

49. The system according to claim 48, wherein the merging criteria comprises a maximum distance and wherein the shortest distance between the object and the tracked object is less than the maximum distance of the merging criteria.

50. The system according to claim 48, wherein the object does not meet the merging criteria, the system further configured to register the object as a new candidate object in the collection of objects.

51. The system according to claim 42, further configured to identify a candidate object in the collection of objects based on a candidate object correspondence.

52. The system according to claim 51, further configured to determine the candidate object correspondence based on a candidate object distance between the object and each of the candidate objects.

53. The system according to claim 52, wherein the candidate object distance comprises at least one of a Euclidean distance, a Manhattan distance, or a Minkowski distance, between the object location within the environment and a candidate object location within the environment.

54. The system according to claim 52, wherein the candidate object comprises the candidate object distance having a shortest distance to the object.

55. The system according to claim 51, further configured to determine a candidate property correspondence between the object and the candidate object, the tracked property correspondence based on correspondence between each of the first and second tracked property, and one or more tracked properties of the candidate object.

56. The system according to claim 54, further configured to merge the object with the candidate object based on a merging criteria.

57. The system according to claim 56, wherein the merging criteria comprises a maximum distance and wherein the shortest distance between the object and the candidate object is less than the maximum distance of the merging criteria.

58. The system according to claim 51, further configured to promote the candidate object as a new tracked object in the collection of objects based on a promotion criteria.

59. The system according to claim 58, wherein the promotion criteria comprises a semantic comprehension threshold criteria.

60. The system according to claim 35, wherein the sensor comprises a range finder for determining a sensor-object distance between the sensor and the object.

61. A system for tracking objects of interest in an environment, the system comprising:
a sensor;
one or more processors, and
a memory storing instructions thereon that, when executed by the one or more processors, configure the system to:
acquire, from the sensor, a plurality of observations of the environment, each observation associated with a pose of the sensor for use in transforming between location coordinates in the plurality of observations and location coordinates in the environment;
identify a candidate object at a location within an observation of the plurality of observations based on a first trackable property associated with an object of interest;
transform, based on the associated sensor pose, the location of the candidate object within the observation to a candidate object location within the environment;
identify an object at a location within a different observation of the plurality of observations based on a second trackable property associated with the object of interest, and
determine a correspondence between the location of the object within the different observation and the candidate object location within the environment and, based on the correspondence:
merge the object with the candidate object, or
disregard the object as the candidate object and register the object as a new candidate object.

62. The system according to claim 61, wherein merging comprises updating the candidate object location within the environment based on the location of the object in the different observation.

63. The system according to claim 61, wherein the first trackable property and the second trackable property comprise a same trackable property associated with the object of interest.

64. The system according to claim 61, wherein merging comprises updating a trackable property of the candidate object based on the first trackable property and the second trackable property.

65. The system according to claim 64, wherein merging comprises updating a semantic comprehension of the candidate object based on the updating of the trackable property.

66. The system according to claim 65, wherein the semantic comprehension comprises a confidence measure of the candidate object comprising the trackable property

67. The system according to claim 65, further configured to promote the candidate object to a tracked object based on the semantic comprehension exceeding a semantic comprehension criteria.

68. A system for tracking objects of interest in an environment, the system comprising:
a sensor;
one or more processors, and
a memory storing instructions thereon that, when executed by the one or more processors, configure the system to:
maintain a collection of a plurality of tracked objects identified in the environment, the plurality of tracked objects each comprising:
one or more trackable properties associated with an object of interest, and
a tracked object location within the environment;
acquire, from the sensor, a plurality of observations of the environment, each observation associated with a pose of the sensor for use in transforming between location coordinates in the plurality of observations and location coordinates in the environment;
identify an object at a location within an observation of the plurality of observations, the object comprising a trackable property associated with the object of interest;
transform, based on the sensor pose associated with the observation, the location of the object within the observation to a predicted location within the environment;
determine a correspondence between the object and each of the plurality of tracked objects based on a distance between the predicted location within the environment and the tracked object location within the environment;
identify the correspondence to a tracked object having the highest correspondence, and, based on the correspondence:
merge the object with the tracked object, or
register the object as a new candidate object for maintaining in a collection of candidate objects.

69. A non-transitory computer-readable storage medium having instructions stored thereon that when executed by one or processors, cause the one or more processors to:
acquire, from a sensor, a plurality of observations of the environment, each observation associated with a pose of the sensor for use in transforming between location coordinates in the plurality of observations and location coordinates in the environment;
identify an object at a location within an observation of the plurality of observations;
transform, based on the pose of the sensor associated with the observation, the location of the object within the observation to an object location within the environment, and
identify the object in a different observation of the plurality of observations based on a correspondence between a location of the object within the different observation and the object location in the environment.

70. The non-transitory computer-readable storage medium according to claim 69, wherein the instructions further configure the one or more processors to:
identify the object in the observation based on a first trackable property associated with an object of interest, and
identify the object in the different observation based on a second trackable property associated with the object of interest.

71. The non-transitory computer-readable storage medium according to claim 70, wherein the instructions further configure the one or more processors to associate each of the first trackable property and the second trackable property with the object location within the environment.

72. The non-transitory computer-readable storage medium according to claim 70, wherein the first trackable property and the second trackable property comprise a same trackable property of the object of interest.

73. The non-transitory computer-readable storage medium according to claim 70, wherein the instructions further configure the one or more processors to update a semantic comprehension of the object based on at least one of the first trackable property, the second trackable property, and the location of the object within the different observation.

74. The non-transitory computer-readable storage medium according to claim 73, wherein the instructions further configure the one or more processors to determine a first observing perspective for the first tracked property and a second observing perspective for the second tracked property based on the sensor pose respectively associated with the observation and the different observation and the location of the object within the environment.

75. The non-transitory computer-readable storage medium according to claim 74, wherein updating the semantic comprehension based on the first trackable property and/or the second trackable property is further based on determining a uniqueness of the first and second observing perspectives.

76. The non-transitory computer-readable storage medium according to claim 70, wherein the instructions further configure the one or more processors to maintain a collection of objects identified in the environment, the collection of objects comprising candidate objects and tracked objects.

77. The non-transitory computer-readable storage medium according to claim 76, wherein the instructions further configure the one or more processors to identify a tracked object in the collection of objects based on a tracked object correspondence.

78. The non-transitory computer-readable storage medium according to claim 77, wherein the instructions further configure the one or more processors to determine the tracked object correspondence based on a tracked object distance between the object and each of the tracked objects.

79. The non-transitory computer-readable storage medium according to claim 78, wherein the tracked object distance comprises at least one of a Euclidean distance, a Manhattan distance, or a Minkowski distance, between the object location within the environment and a tracked object location within the environment.

80. The non-transitory computer-readable storage medium according to claim 78, wherein the tracked object comprises the tracked object distance having a shortest distance to the object.

81. The non-transitory computer-readable storage medium according to claim 76, wherein the instructions further configure the one or more processors to determine a tracked property correspondence between the object and the tracked object, the tracked property correspondence based on correspondence between each of the first and second tracked property, and one or more tracked properties of the tracked object.

82. The non-transitory computer-readable storage medium according to claim 80, wherein the instructions further configure the one or more processors to merge the object with the tracked object based on a merging criteria.

83. The non-transitory computer-readable storage medium according to claim 82, wherein the merging criteria comprises a maximum distance and wherein the shortest distance between the object and the tracked object is less than the maximum distance of the merging criteria.

84. The non-transitory computer-readable storage medium according to claim 82, wherein the object does not meet the merging criteria, wherein the instructions further configure the one or more processors to register the object as a new candidate object in the collection of objects.

85. The non-transitory computer-readable storage medium according to claim 76, wherein the instructions further configure the one or more processors to identify a candidate object in the collection of objects based on a candidate object correspondence.

86. The non-transitory computer-readable storage medium according to claim 85, wherein the instructions further configure the one or more processors to determine the candidate object correspondence based on a candidate object distance between the object and each of the candidate objects.

87. The non-transitory computer-readable storage medium according to claim 86, wherein the candidate object distance comprises at least one of a Euclidean distance, a Manhattan distance, or a Minkowski distance, between the object location within the environment and a candidate object location within the environment.

88. The non-transitory computer-readable storage medium according to claim 86, wherein the candidate object comprises the candidate object distance having a shortest distance to the object.

89. The non-transitory computer-readable storage medium according to claim 85, wherein the instructions further configure the one or more processors to determine a candidate property correspondence between the object and the candidate object, the tracked property correspondence based on correspondence between each of the first and second tracked property, and one or more tracked properties of the candidate object.

90. The non-transitory computer-readable storage medium according to claim 88, wherein the instructions further configure the one or more processors to merge the object with the candidate object based on a merging criteria.

91. The non-transitory computer-readable storage medium according to claim 90, wherein the merging criteria comprises a maximum distance and wherein the shortest distance between the object and the candidate object is less than the maximum distance of the merging criteria.

92. The non-transitory computer-readable storage medium according to claim 85, wherein the instructions further configure the one or more processors to promote the candidate object as a new tracked object in the collection of objects based on a promotion criteria.

93. The non-transitory computer-readable storage medium according to claim 92, wherein the promotion criteria comprises a semantic comprehension threshold criteria.

94. The non-transitory computer-readable storage medium according to claim 69, wherein the sensor comprises a range finder for determining a sensor-object distance between the sensor and the object.

95. A non-transitory computer-readable storage medium having instructions stored thereon that when executed by one or processors, cause the one or more processors to:
acquire, from a sensor, a plurality of observations of the environment, each observation associated with a pose of the sensor for use in transforming between location coordinates in the plurality of observations and location coordinates in the environment;
identify a candidate object at a location within an observation of the plurality of observations based on a first trackable property associated with an object of interest;
transform, based on the associated sensor pose, the location of the candidate object within the observation to a candidate object location within the environment;
identify an object at a location within a different observation of the plurality of observations based on a second trackable property associated with the object of interest, and
determine a correspondence between the location of the object within the different observation and the candidate object location within the environment and, based on the correspondence:
merge the object with the candidate object, or
disregard the object as the candidate object and register the object as a new candidate object.

96. The non-transitory computer-readable storage medium according to claim 95, wherein merging comprises updating the candidate object location within the environment based on the location of the object in the different observation.

97. The non-transitory computer-readable storage medium according to claim 95, wherein the first trackable property and the second trackable property comprise a same trackable property associated with the object of interest.

98. The non-transitory computer-readable storage medium according to claim 95, wherein merging comprises updating a trackable property of the candidate object based on the first trackable property and the second trackable property.

99. The non-transitory computer-readable storage medium according to claim 98, wherein merging comprises updating a semantic comprehension of the candidate object based on the updating of the trackable property.

100. The non-transitory computer-readable storage medium according to claim 99, wherein the semantic comprehension comprises a confidence measure of the candidate object comprising the trackable property

101. The non-transitory computer-readable storage medium according to claim 99, wherein the instructions further configure the one or more processors to promote the candidate object to a tracked object based on the semantic comprehension exceeding a semantic comprehension criteria.

102. A non-transitory computer-readable storage medium having instructions stored thereon that when executed by one or processors, cause the one or more processors to:
maintain a collection of a plurality of tracked objects identified in the environment, the plurality of tracked objects each comprising:
one or more trackable properties associated with an object of interest, and
a tracked object location within the environment;
acquire, from the sensor, a plurality of observations of the environment, each observation associated with a pose of the sensor for use in transforming between location coordinates in the plurality of observations and location coordinates in the environment;
identify an object at a location within an observation of the plurality of observations, the object comprising a trackable property associated with the object of interest;
transform, based on the sensor pose associated with the observation, the location of the object within the observation to a predicted location within the environment;
determine a correspondence between the object and each of the plurality of tracked objects based on a distance between the predicted location within the environment and the tracked object location within the environment;
identify the correspondence to a tracked object having the highest correspondence, and, based on the correspondence:
merge the object with the tracked object, or
register the object as a new candidate object for maintaining in a collection of candidate objects.
